(19) United States
(12) Patent Application Publication
(10) Pub. No.: US 2026/0300572 A1
(43) Pub. Date: Oct. 1, 2026

(54) SYSTEM AND METHOD FOR MULTI-SCALE MULTI-PHYSICS SIMULATION USING LOCAL FREQUENCY DOMAIN COUPLING

(71) Applicant: Bayris Inc., Mountain View, CA (US)

(72) Inventor: Jorge Campos, Mountain View, CA (US)

(73) Assignee: Bayris Inc., Mountain View, CA (US)

(21) Appl. No.: 19/285,954

(22) Filed: Jul. 30, 2025

Related U.S. Application Data
(60) Provisional application No. 63/781,833, filed on Apr. 1, 2025.

(51) Int. Cl. G06F 30/20; G06F 119/06

(52) U.S. Cl. CPC G06F 30/20; G06F 2119/06

(57) ABSTRACT

A system and method for multi-scale multi-physics simulation uses phase-amplitude vectors to represent physical states in a frequency domain. Each phase-amplitude vector contains amplitude coefficients for multiple frequency components that can capture physical phenomena across various scales. The system performs local vector-coupling operations between adjacent simulation points to model energy transfer and physical interactions according to conservation laws. The vector coupling operations can include frequency-mixing operations that generate sum and difference frequencies, enabling nonlinear effects and cross-mode interactions. The frequency-domain representation allows quantum mechanical effects to emerge from purely local operations, eliminating the need for non-local calculations typical in conventional quantum simulations. This reduces computational complexity from O(N²) to O(N) for N-point systems, which enables efficient parallel processing across compute nodes. The system can unify quantum, molecular, and continuum scales within a single computational framework, which facilitates simulating complex physical systems previously intractable due to mathematical incompatibilities between simulation domains.

### RELATED APPLICATIONS

This application claims benefit of U.S. Provisional Application No. 63/781,833, Attorney Docket Number BYRS25-1001PSP, titled “SYSTEM AND METHOD FOR TIME-STEPPED FREQUENCY ANALYSIS,” by inventor Jorge Campos, filed 1 Apr. 2025.

### TECHNICAL FIELD

The present disclosure generally relates to simulators. More specifically, the present disclosure relates to a system and method for updating a frequency-based state at a simulation point via frequency-coupling operations with adjacent points.

### BACKGROUND

Modern scientific and engineering research of physical systems is oftentimes accelerated via computer simulations. Physical systems often exhibit complex behaviors across multiple scales, from quantum effects at the atomic level to macroscopic phenomena observable in everyday life. However, it is difficult to accurately model these multi-scale behaviors using existing simulation techniques.

Oftentimes, researchers segment the physical system into distinct domains based on scale or physical phenomena. Computer systems that use traditional simulation methods typically combine separate mathematical frameworks for different physics domains. For example, as illustrated in FIG. 1, a computer system 100 may separate the domains by using separate simulators 112-116 for different physics domains. A central simulation controller 110 in memory 104 that runs on a CPU 102 can configure a quantum domain simulator 112 to load a density functional theory (DFT) model 118 and store the simulation results in simulation data 124 in a storage drive 106. Similarly, simulation controller 110 may configure an electromagnetics (EM) simulator 114 to load and simulate an EM model 120 using Maxwell's equations, and may configure a continuum domain simulator 116 to load and simulate models using finite-element methods (FEM). Simulators 112, 114, and 116 may each store their separate simulation results into simulation data 124. Subsequently, simulation controller 110 may then combine information from the various separate domains in simulation data 124 to start another simulation run that fine-tunes or advances the simulations performed by simulators 112, 114, and 116.

These different simulators operate separately, using their own memory regions, and each utilizes their own custom data structures and workflows (e.g., using differential equations or matrix operations), which limits their ability to efficiently model interactions across scales or between physical phenomena. Furthermore, traditional quantum and FEM simulation systems solve physical problems as eigensystems, which can require matrix operations that become computationally prohibitive for large systems. These matrix operations use iterative solvers that consume significant computational resources and limit the size and complexity of systems that can be simulated.

Simulation controller 110 may attempt to implement a multiphysics solution by creating interfaces that post-process the results from one simulator to generate inputs to another simulator; however, these interfaces often introduce numerical approximations and instabilities that compromise simulation accuracy. This segmented-domain workflow leads to inefficient simulations, and creates artificial boundaries between domains that do not exist in nature.

### BRIEF SUMMARY

Embodiments of the present disclosure provide a computer-implemented method, system, and non-transitory computer-readable medium for simulating physical systems using phase-amplitude vectors in a unified mathematical framework. The system operates on a mathematical model that defines a spatial domain comprising multiple simulation points, where each simulation point includes physical modes representing physical phenomena within the system.

In some embodiments, the system stores phase-amplitude vectors in memory, where each vector can represent a physical state for a physical mode at a simulation point. A phase-amplitude vector can include multiple frequency components that define amplitudes across a frequency spectrum, with frequency components corresponding to measurable physical frequencies of electromagnetic radiation, phonon vibrations, or electron oscillations in the physical system. Each frequency component comprises an amplitude coefficient specifying an amplitude for a corresponding frequency.

In some embodiments, the system performs vector-coupling operations between phase-amplitude vectors to model energy transfer between physical states according to physical conservation laws. The vector-coupling process can involve obtaining frequency components from different vectors, identifying target frequency components based on frequency value combinations, and generating amplitude contributions to update the vectors.

In some embodiments, the system can perform sum and difference frequency-mixing operations that can enable nonlinear effects and cross-mode interactions. The system can enforce energy conservation by calculating total energy values before and after operations, and can apply scaling factors to preserve energy across vector-coupling operations.

In some embodiments, the system can leverage graphics processing units with shared memory for efficient parallel processing, enabling simulation of complex multiphysics systems across multiple scales within a single computational framework.

### BRIEF DESCRIPTION OF DRAWINGS

FIG. 1 illustrates a computer system that runs separate simulations for different physical domains.

FIG. 2 illustrates a computer system that can use phase-amplitude vectors to simulate multiple physical domains in one simulation.

FIG. 3A illustrates a data structure for a phase-amplitude vector of a multi-physics simulation system.

FIG. 3B illustrates an exemplary frequency mapping function, which can map array indices to a wavelength, a frequency, or a complex basis function.

FIG. 3C illustrates an exemplary non-linear mapping function, configurable via a mapping scale parameter, S.

FIG. 3D illustrates a phase-amplitude vector data structure whose frequency component entries can have explicit frequency or wavelength values.

FIG. 4A illustrates flow chart for a vector-coupling process performed by a multi-physics simulation system.

FIG. 4B illustrates a flow chart for a vector-coupling process that runs on a graphics processing unit (GPU) of a multi-physics simulation system.

FIG. 5 illustrates a flow chart for a frequency-mixing operation performed by a multi-physics simulation system.

FIG. 6 illustrates a flow chart for initializing a MixingConfiguration object in a multi-physics simulation system.

FIG. 7 illustrates an architecture for a distributed multi-physics simulation system.

FIG. 8 illustrates a flow chart for executing a multi-physics simulation performed by a multi-physics simulation system.

FIG. 9 illustrates a flow chart for executing a simulation time-step in a multi-physics simulation system.

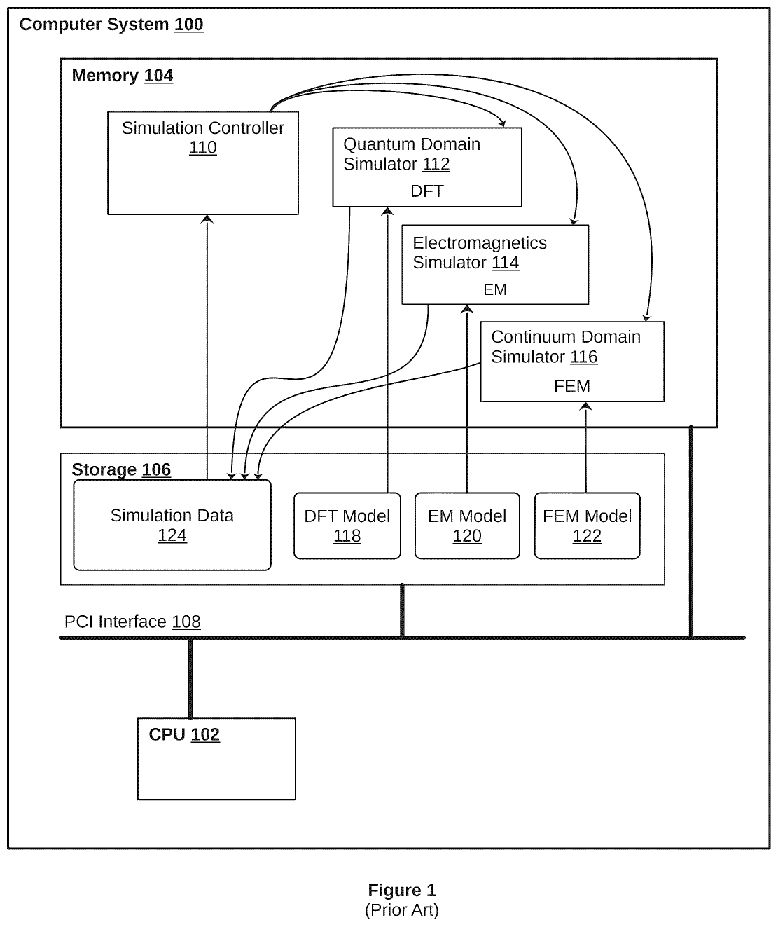

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

### Overview

Computer simulation of physical systems, oftentimes referred to as computational physics or multiphysics, is an essential tool for scientific research, engineering design, and technological innovation. Researchers and engineers oftentimes rely on simulations to understand complex physical phenomena, test design hypotheses, and predict system behavior without expensive physical prototyping.

Physical reality encompasses phenomena spanning many orders of magnitude in both space and time, from quantum-mechanical processes at the atomic scale or the nanometer scale, to macroscopic behaviors at continuum scales that can be modeled with classical physics. These physical phenomena (hereinafter also referred to as “energy modes”, “physical modes” or “modes”) do not exist in isolation; rather, they continuously interact across scales through frequency-dependent mechanisms. For example, atomic vibrations (e.g., phonon mode energy) can influence various material phenomena at the microscopic scale; macroscopic phenomena can also affect structural behavior at the macroscopic scale. Moreover, electromagnetic waves can interact with matter across multiple spatial and temporal scales simultaneously.

Embodiments of the present disclosure provide a simulation system that includes a unified computational framework for multiphysics simulations that may span multiple simulation scales, by using a phase-amplitude vector data structure to represent physical states as frequency spectra that evolve through local interactions. Unlike conventional physics simulators, this simulation system stores frequency-domain state information locally at each spatial point in the simulation space, and uses vector-coupling operations (e.g., frequency mixing) to propagate interactions locally. A phase-amplitude vector encodes a physical mode's state through a set of amplitude and phase coefficients across multiple frequency components, where components at lower frequencies can represent long-range, classical-like behaviors while components at higher frequencies can represent localized quantum effects. This frequency-based representation enables the same mathematical structure to naturally describe phenomena in molecular, quantum, and/or macroscopic (continuum) scales. Hereinafter, the term “vector” may also be used to refer to a phase-amplitude vector of the present disclosure.

The simulation system of the present disclosure represents a fundamental reconceptualization of computational physics by enabling quantum mechanical effects, such as entanglement, interference, and tunneling, to emerge from purely local coupling operations between phase-amplitude vectors. These operations, referred to hereinafter as “vector coupling,” encompass mechanisms by which phase-amplitude vectors interact to exchange information and evolve, including frequency mixing between frequency components, enforcement of physical constraints such as the Pauli exclusion principle, and conservation of fundamental quantities such as energy and momentum. The vector coupling operations of the present disclosure operate locally, either within a single point or between adjacent points in the simulation space. Hereinafter, the phrase “local interaction”, “local coupling”, or any variation thereof corresponds to a vector-coupling operation within a simulation point, or between adjacent simulation points. Unlike conventional quantum mechanics simulation methods, the simulation system does not require using a wavefunction to represent a region of space, does not require using memory kernels that store historical temporal information, and does not require explicit non-local calculations.

By representing local physical states directly in the frequency domain and evolving them through vector coupling, the simulation system achieves what decades of research have struggled with: unifying quantum and classical descriptions without artificial boundaries between scales. The approach in this system eliminates several foundational constructs of traditional quantum mechanics while preserving essential quantum phenomena, and reduces computational complexity for an N-point system from O(N²) in conventional quantum methods to O(N) through local operations. This paradigm shift enables accurate simulation of complex multiphysics systems that were previously intractable, from molecular reactions involving quantum effects to large-scale materials exhibiting emergent behaviors, within a single, computationally efficient mathematical framework that naturally bridges the quantum-classical divide.

In some embodiments, the simulation system can instantiate phase-amplitude vectors to represent various modes across different scales. Each point in a simulation is associated with a physical scale, such as a molecular, a quantum, or a continuum scale. Moreover, the scale assigned to a simulation point can govern which types of physical modes the simulation system is to instantiate at that point, and which physical rules the simulation system should use during vector-coupling operations.

The molecular, quantum, and continuum scales can support physical modes including but not limited to thermal, electric field, magnetic field, photon, phonon, stress, strain, and torsion modes. For continuum-scale phenomena, the physical modes can include plastic deformation, elastic deformation, fluid dynamics, strain rate, and vorticity modes. For quantum-scale phenomena, the physical modes can include electron, plasmon, polariton, magnon, quantum spin, spin current, and Berry curvature modes.

For molecular simulations, the simulation system partitions three-dimensional space into regions corresponding to atomic structure: nuclei, core shells surrounding nuclei, valence shells surrounding core shells, and charge-density regions between atoms. The simulator can instantiate each of these molecular-simulation regions as a different type of physical scale, which allows the physics simulator to apply a set of physics rules that are specific to the corresponding molecular region. Nuclear regions can support nuclear spin modes. Core shells, valence shells, and charge-density regions can support spin-up density, spin-down density, current density, and exchange-correlation modes. Valence shells additionally can support orbital-character modes that can capture the directional nature of chemical bonding.

The computational physics simulation system described herein can implement frequency-dependent interactions through vector coupling that can capture wave propagation, dispersion, nonlinear effects, quantum correlations, and decoherence. Compared with conventional methods that stitch together different physics simulators, the simulation system of the present disclosure is more efficient to distribute across a computer cluster: couplings are implemented locally between adjacent points, using a frequency spectrum that achieves better simulation accuracy, and supports a plurality of physical modes to provide more simulation capabilities. This local-coupling approach facilitates simulations of complex multiphysics systems that were previously intractable due to computational limitations or mathematical incompatibilities between different simulation domains.

The frequency components in each phase-amplitude vector correspond to the same physical frequencies that can be measured experimentally from a physical system through various techniques. For example, for electromagnetic modes, the frequencies can be detected using network analyzers, spectrum analyzers, or optical spectrometers. For phonon modes, the frequencies correspond to physical phenomena observable through Raman spectroscopy, infrared spectroscopy, or neutron scattering. For electron oscillations, the frequencies can be detected through photoemission spectroscopy or electron energy loss spectroscopy. This direct correspondence between simulated and measurable frequencies enables experimental validation of simulation results and facilitates the design of devices with predicted performance characteristics.

### Multiphysics Domain Mapping

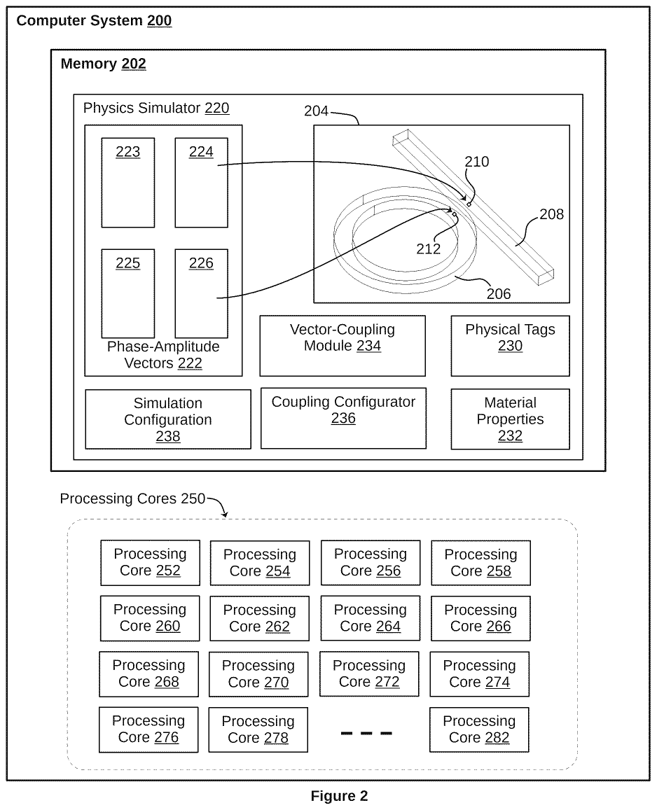

FIG. 2 illustrates a multiphysics simulation system implemented by a computer system 200 in accordance with some embodiments of the present disclosure. Computer system 200 can include a memory 202 and processing cores 250, which can include a plurality of processing cores 252-282. Processing cores 250 can provide the computational resources for executing the physics simulations across multiple domains and scales, via parallel processing algorithms. In some embodiments, processing cores 250 may reside on a multi-core central processing unit (CPU) or may be distributed across a plurality of CPUs on one or more computer systems. Alternatively, or in addition, processing cores 250 may reside inside a graphics processing unit (GPU) or a plurality of GPUs.

In some embodiments, the GPU may be a general-purpose GPU (GPGPU) processor, a stream processor (SP), or a shared-memory multiprocessor (SMP). Alternatively, the GPU may be an integrated graphics processing unit (IGPU) or a hybrid GPU, which can make use of the host computer system's random-access memory (RAM) for at least a portion of the GPU's global memory layer. Hereinafter, the term “GPU” may refer to any numerical accelerator such as a GPU, a GPGPU, a stream processor (SP) or shared-memory multiprocessor (SMP) that includes dedicated on-board global memory, an IGPU that uses the host computer's RAM as the IGPU's global memory layer, and/or any SP, SMP, GPGPU, GPU, or hybrid GPU that includes dedicated global memory and may also utilize RAM as extended global memory. The GPU's cores or runtime threads may be partitioned into “blocks” or “thread-blocks”, where each block has access to a dedicated shared memory region that can be orders of magnitude faster than the global memory layer of the GPU. The disclosed simulation system can, for example, store simulation points and their phase-amplitude vectors for a CAD model 204 in a global memory region of the GPU, and a GPU thread block may use its faster shared memory region to store temporary copies of the phase-amplitude vectors and their results while performing a vector-coupling operation.

Memory 202 can include a random-access memory (RAM) accessible by a CPU on computer system 200, or can include a GPU global memory accessible by GPU processing cores 252-282. Memory 202 can store a physics simulator 220, and can store a CAD model 204 that may serve as a unified physics model where different physical domains coexist and interact within the same mathematical framework. Physics simulator 220 can execute on processing cores 250 to perform the multiphysics simulations using CAD model 204 and associated physical properties. CAD model 204 can include a mathematical model that defines a spatial domain for the physical system being simulated, such as via a point cloud, a solid model, a geometric model, a non-uniform rational basis spline (NURBS) model, etc.

The simulator can discretize the mathematical model into a collection of connected regions that are to represent localized physical phenomena. For example, the system may discretize the mathematical model into a collection of interconnected mesh nodes whose connections form mesh elements (e.g., to form a curve element, a surface element, or a volume element). The discretized mesh elements may be a structured mesh (e.g., a grid), or an unstructured mesh with non-uniform mesh element shapes and/or dimensions. A “volume” mesh element can have an adjacent neighbor on each of its surfaces, and a “surface” mesh element can have an adjacent neighbor on each of its edges. In some embodiments, the system can use surface or volume mesh elements as the simulation points that model the evolution of physical phenomena, and may instantiate a phase-amplitude vector for each physical phenomena (e.g., physical mode) that needs to be tracked at a respective mesh element.

For example, CAD model 204 can represent a photonic ring resonator structure, which can include at least a simulation region 206 that can form a ring structure of the resonator, and a simulation region 208 that can form a straight bus waveguide. In this example, simulator 220 can partition the ring into a plurality of discretized mesh elements for region 206, and can partition the bus into a plurality of discretized mesh elements for region 208. This discretization enables simulator 220 to model the continuous physical structure using a finite set of computational elements.

Memory 202 can store physical tags 230 for CAD model 204, such as a physical tag for ring simulation region 204 and a physical tag for bus region 206. These physical tags can provide a reference point for a group of similar mesh elements in CAD model 204, such as by assigning a physical name to the group. Physics simulator 220 may associate specific material properties and physical characteristics to a physical tag, thereby applying those properties and characteristics to the mesh elements which share that physical tag. For example, a user may configure a simulation configuration 238 so that the physical tags for ring simulation region 206 and bus waveguide region 208 associate the corresponding mesh elements with “silicon dioxide” material properties, and so that the physical tags for the surrounding substrate regions (not shown) may associate those mesh elements with “silicon” material properties.

The user may also configure simulation configuration 238 to specify a physics scale for a respective mesh element, such as to specify that a mesh element is a part of a molecular-scale simulation (e.g., a nucleus, a core shell region, a valence shell region, or a charge-density region), part of a quantum-scale simulation (e.g. a nanoscale simulation that can track entanglement correlations), or part of a continuum-scale simulation.

Moreover, the user may configure simulation configuration 238 to activate one or more physical modes for mesh elements associated with a physical tag, which would cause the physics simulator to instantiate phase-amplitude vectors for these modes during a physics simulation. For example, the user may configure simulation configuration 238 to activate electromagnetic, photon, and plasmon modes for the physical tag that encompasses the ring and the waveguide, and physics simulator 220 may use this configuration to instantiate phase-amplitude vectors for the electromagnetic, photon, and plasmon modes for ring elements 206 and waveguide elements 208 during the multiphysics simulation. As a further example, the user may similarly configure the simulation configuration 238 so that physics simulator 220 instantiates phase-amplitude vectors for electromagnetic, phonon, and plasmon modes for mesh elements that encompass the surrounding substrate region.

Hence, physical tags 230 can allow a user to specify which physical phenomena (e.g., modes) to track across each mesh region, and to specify their material attributes that govern how simulator 220 should model the mode couplings in a mesh region, such as to model electromagnetic waves, thermal effects, and mechanical stresses for a physical region.

This photonic ring resonator example illustrates how physics simulator 220 can represent multiple physical domains simultaneously (e.g., optical, thermal, mechanical) within a unified computational framework. The phase-amplitude vectors instantiated at mesh elements can capture the multi-scale nature of physical phenomena, including fast optical oscillations and slower thermal diffusion. The vector coupling operations can model how these phenomena may interact according to material-specific physical laws. This unified approach eliminates artificial boundaries between physical domains and scales, enabling more accurate simulation of complex multiphysics systems, such as integrated photonic devices.

Physics simulator 220 can include a plurality of phase-amplitude vectors 222, such as a phase-amplitude vector 224 for a physical mode at a mesh element 210 on the bus and a phase-amplitude vector 226 for a physical mode at a mesh element 212 on the ring. Each phase-amplitude vector can represent a mode's physical state at its corresponding mesh element, by representing a direct current (DC) component and one or more frequency components that together encompass the mode's state. If mesh elements 210 and 212 are sufficiently close and within a coupling region for the ring and bus and vectors 224 and 226 represent electric fields, simulator 220 may simulate how electromagnetic information may propagate between vectors 224 and 226, either directly or indirectly via intermediating mesh elements. Phase-amplitude vectors 224 and 226 may show an evanescent coupling of the ring and the bus via complex numbers that provide amplitude and phase information for a DC component and for one or more frequency components.

Physics simulator 220 can also include a material properties database 232 that can store physical attributes of different materials, and can include variations to the physical attributes for different physical modes and/or physical scales. For the photonic ring resonator and/or the bus, for example, these properties can include optical refractive indices, thermal conductivities, mechanical elasticity constants, and various nonlinear coefficients that govern how these properties interact.

Physics simulator 220 may also include a vector-coupling module 234, which performs same-mode or cross-mode coupling operations, either within a mesh element or between adjacent mesh elements, to propagate energy information for a plurality of frequencies. Vector-coupling module 234 can implement the mathematical operations that model how physical phenomena evolve and interact across the simulation domain. In some embodiments, these vector couplings can include general frequency-mixing operations, such as a 1^{st}, 2^{nd}, 3^{rd}, or 4^{th} order mixing operation. For example, for the ring resonator, module 234 can perform the frequency-mixing operations that model how optical waves propagate around the ring, how they couple to the bus waveguide, how optical absorption generates thermal energy that may cause mechanical deformation, and how the mechanical deformation may in turn affect the optical wave propagations.

In some other embodiments, the vector coupling operations can be specific to the mode types that are interacting, such as to implement a Pauli exclusion principle on the electron modes within a valence shell region of a molecular simulation. The Pauli exclusion principle ensures that no two electrons with the same spin can occupy the same quantum state, which vector-coupling module 234 can enforce by implementing coupling operations that suppress forbidden state combinations. Similarly, vector-coupling module 234 can implement spin-spin coupling rules for magnetic modes, where the interaction strength depends on the relative spin orientations and spatial separation. For chemical bond formation, vector-coupling module 234 may apply electron coupling rules between electron modes in overlapping valence shells to model covalent bonding, ionic interactions, or metallic delocalization. These mode-specific coupling interactions allow the physics simulator to capture the unique physical laws governing different types of quantum and classical phenomena that need to be simulated between pairs of phase-amplitude vectors of the same or different mode types.

Coupling configurator 236 configures the operation settings used by vector-coupling module 234. These operation settings instruct vector-coupling module 234 on how to propagate physics phenomena across mesh elements or within a mesh element, across physical modes or within a single physical mode. Coupling configurator 236 initializes a vector-coupling operation (e.g., a frequency-mixing operation) between one or more phase-amplitude vectors, by using the vector mode(s) and the material properties to generate specific mathematical parameters that govern the vector-coupling operations. For the ring resonator, the vector-coupling parameters may model how strongly optical modes couple between the ring and bus waveguides based on their geometry and material properties (e.g., when configuring photon modes), how efficiently optical energy converts to thermal energy due to absorption (e.g., when configuring phonon and/or thermal modes), and how thermal expansion affects the optical properties through stress-induced refractive index changes (e.g., when configuring physical modes for phonon, thermal, stress, strain, etc.).

### Phase-Amplitude Vector Structure

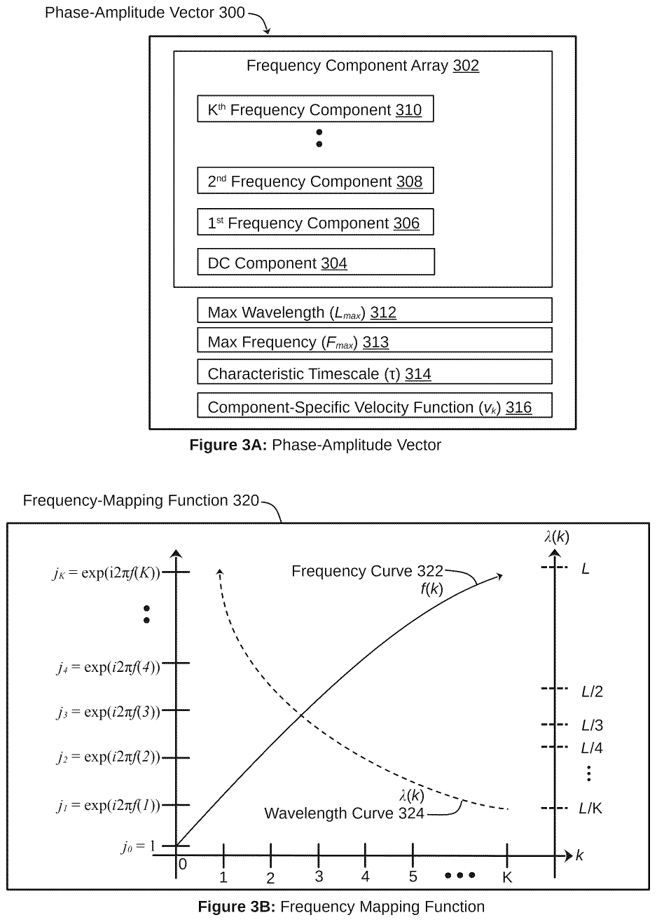

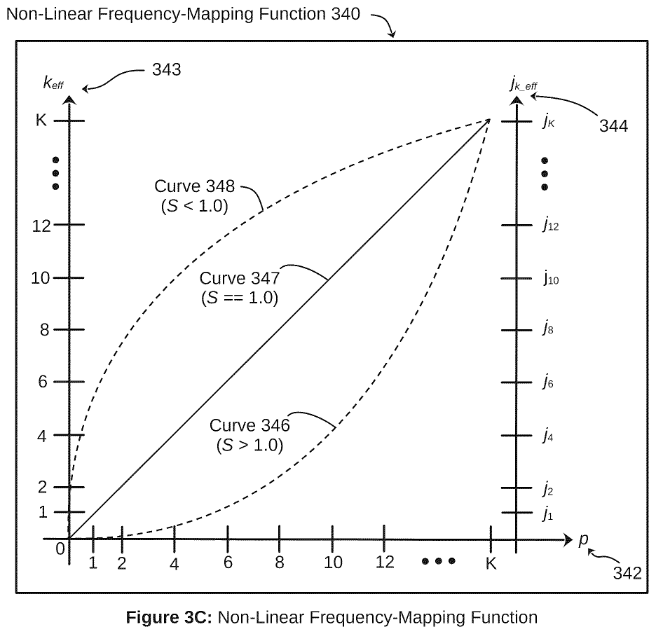

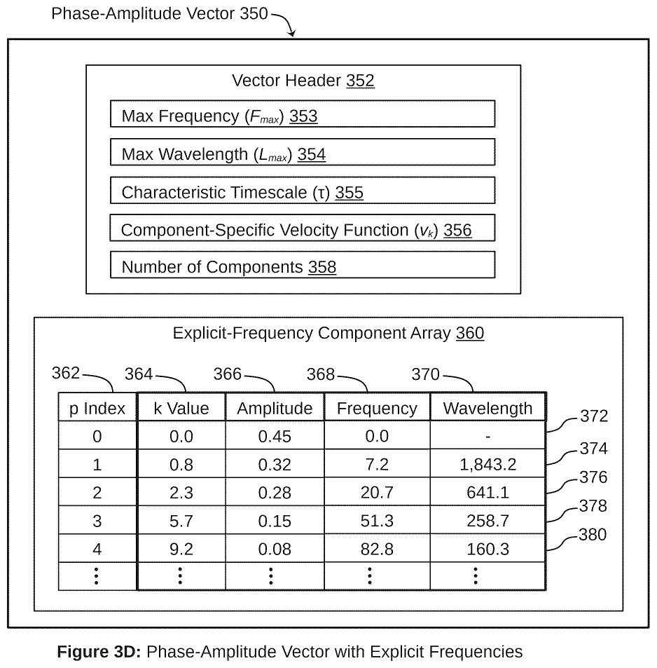

FIG. 3A illustrates a data structure for a phase-amplitude vector 300, which can serve as the fundamental mathematical representation for physical states in accordance with some embodiments of the present disclosure. Phase-amplitude vector 300 can represent physical phenomena for a physical mode at a particular physical scale, using a unified mathematical structure that captures both amplitude and phase information for a plurality of frequency components.

The phase-amplitude vector contains a DC component and K frequency components, where each component stores a complex-valued amplitude coefficient representing the magnitude and phase of that component's contribution to the overall local oscillatory state. Frequency component array 302 can contain a DC component 304 (corresponding to index k=0), and K frequency components 306-310 (corresponding to indices k∈[1, K]). Hence, the first frequency component 306 corresponds to k=1, the second frequency component 308 corresponds to k=2, and continuing to the highest frequency component 310 that corresponds to k=K.

DC component 304 (with amplitude do) represents the immediate local state, storing the average or static component of the physical quantity being modeled, which corresponds to the overall steady state without oscillatory behavior. For example, in electromagnetic simulations, the DC component can represent the static electric field, while in quantum simulations, the DC component can represent the time-independent component of a quantum state.

Phase-amplitude vector 300 can also include properties that can be used to map a component index k to a wavelength or frequency value. These properties can include a max wavelength 312 (Lₘₐₓ) for the largest wavelength that vector 300 can represent, a max frequency 313 (Fₘₐₓ) for the highest frequency that vector 300 can represent, and a characteristic timescale 314 (τ) that defines the natural time evolution scale for vector 300. These properties can also include a component-specific velocity function 316 (vₖ) that defines the speed at which a mode's waves may propagate in the medium for any component k.

In some embodiments, phase-amplitude vector 300 may implement velocity function 316 using coefficients that implement a Padé approximant. The system may generate the Padé approximant so that it computes a value for vₖ based on a real number, such as a component's array index k, based on the component's frequency value (e.g., to map the frequency value to a corresponding wavelength value), or based on the component's wavelength value (e.g., to map the wavelength value to a corresponding frequency value).

In some embodiments, phase-amplitude vector 300 can operate either in a frequency-primary configuration, or in a wavelength-primary configuration. In a frequency-primary configuration, the simulation system can distribute frequency values across the frequency components of phase-amplitude vector 300 based on max frequency 313 using the relationship:

$$f ( k ) = {F}_{max} \frac{k}{K} \qquad ( 1 )$$

where f(k) is the physical frequency corresponding to component index k, and Fₘₐₓ corresponds to max frequency 313. Alternatively, in a wavelength-primary configuration, the simulation system can distribute wavelength values across the frequency components of phase-amplitude vector 300 based on max wavelength 312 using the relationship:

$$λ ( k ) = \frac{{L}_{max}}{k} \qquad ( 2 )$$

where Lₘₐₓ is the max wavelength, and λ(k) is the physical wavelength corresponding to component index k.

For example, when phase-amplitude vector 300 is operating in a frequency-primary configuration, the first frequency component 306 corresponds to the vector's minimum frequency

$${F}_{min} = f ( 1 ) = \frac{{F}_{max}}{K} ,$$

the second frequency component 308 corresponds to

$$f ( 2 ) = \frac{2 {F}_{max}}{K} ,$$

and continuing to the vector's highest frequency component 310 f(K)=Fₘₐₓ. Similarly, when phase-amplitude vector 300 is operating in a wavelength-primary configuration, the first frequency component 306 corresponds to the vector's maximum wavelength λ(1)=Lₘₐₓ, the second frequency component 308 corresponds to

$$λ ( 2 ) = \frac{{L}_{max}}{2} ,$$

and continuing to the vector's highest frequency component that corresponds to the vector's smallest wavelength

$${L}_{min} = λ ( K ) = \frac{{L}_{max}}{K} .$$

Max wavelength 312 defines the spatial scope of the phase-amplitude vector's representation, where the DC component represents non-oscillatory phenomena at the max wavelength scale. When a vector is in a frequency-primary configuration, the simulation system can derive the value for max wavelength 312 (e.g., λ(1)) and the associated physical wavelength for any frequency component by using:

$$λ ( k ) = \frac{{v}_{k}}{f ( k )} = \frac{{v}_{k}}{{F}_{max}} \cdot \frac{K}{k} \qquad ( 3 )$$

where:
Fₘₐₓ corresponds to max frequency 313; and
vₖ is the component-specific wave velocity, for the material and physical mode being modeled, corresponding to the frequency for component index k.

When a vector is in a wavelength-primary configuration, the system can derive the value for max frequency 313 (e.g., f(K)) and the associated physical frequency for any frequency component via the relationship:

$$f ( k ) = \frac{{v}_{k}}{λ ( k )} = {v}_{k} \cdot \frac{k}{{L}_{max}} \qquad ( 4 )$$

FIG. 3B illustrates a frequency mapping function 320 that maps the abstract index space of the vector to the physical meaning of each component. Mapping function 320 establishes a relationship between component indices and their physical wavelengths, physical frequencies, or complex basis functions in accordance with some embodiments of the present disclosure. In FIG. 3B, the horizontal axis of mapping function 320 shows a component index scale, which includes indices from 0 to K.

Wavelength curve 324 and the right-side vertical axis of FIG. 3B shows the wavelengths that map to indices 1 to K, which shows a multiplicative inverse relationship between component indices k and wavelengths. This relationship between component indices and wavelengths can be expressed in terms of equation (2) for a wavelength-primary configuration, and can be expressed in terms of equation (3) for a frequency-primary configuration.

In a frequency-primary configuration, the system can compute the associated physical frequency for a component index via equation (1) and can compute the associated physical wavelength via equation (3). In a wavelength-primary configuration, the system can compute the associated physical frequency for a component index via equation (4) and can compute the associated physical wavelength via equation (2).

The left-side vertical axis of FIG. 3B shows the complex basis functions jₖ that map to indices 0 to K, and are computed based on the frequency function ƒ(k). Frequency curve 322 shows the frequency values for f(k), which map to indices 0 to K. The complex basis functions jₖ (shown on the left-side vertical axis) represent oscillatory basis functions with specific frequencies determined by the component index k and frequency function ƒ(k).

We can derive the amplitude values for each complex basis function jₖ based on discrete Fourier transform, by treating each mesh element as a discretized point, which behaves as an open system that interacts with its adjacent elements (e.g., via frequency mixing interactions, or any other local coupling operation required by the vector mode types):

$${j}_{k} = exp ( i {ω}_{k} ) = exp ( i 2 π \cdot f ( k ) ) \qquad ( 5.1 )$$

where i is the imaginary unit, and w is the angular frequency of the k^{th} component in the cell. In a frequency-primary configuration, the angular velocity depends on Fₘₐₓ and the component index k, resulting in the complex basis function:

$${j}_{k} = exp ( i 2 π \cdot {F}_{max} \frac{k}{K} ) \qquad ( 5.1 )$$

On the other hand, in a wavelength-primary configuration, the angular velocity depends on component index k, max wavelength Lₘₐₓ, and the component-specific wave velocity in the material vₖ, resulting in the complex basis function:

$${j}_{k} = exp ( \frac{i 2 π {v}_{k}}{{λ}_{k}} ) = exp ( i 2 π \cdot {v}_{k} \frac{k}{{L}_{max}} ) \qquad ( 5.2 )$$

These component-specific velocity values vₖ can be derived through an internal function such as a Padé approximant or other mathematical formulation that can capture the dispersion relation of the material.

The structure's separation of complex frequency basis functions (jₖ) from amplitude and phase information (via complex coefficients) simplifies computational operations while maintaining the ability to represent oscillatory behavior. The mathematical formulation of the phase-amplitude vector can be expressed as:

$$B = {\sum }_{k = 0}^{K} {a}_{k} {j}_{k} \qquad ( 6.1 )$$

where:
B is the phase-amplitude vector;
aₖ are the amplitude coefficients (which may be real or complex); and
jₖ are the complex basis functions representing oscillatory modes at specific frequencies.

The representation in equation (6.1) separates the complex frequency basis functions (j₀ through j_{K}) from the coefficients (a₀ through a_{K}) that specify how much each frequency contributes to the overall state. This separation offers computational advantages by allowing each processing core of the simulation system to operate on a different component index k, while the complete phase-amplitude vector represents wave-like behavior through the superposition of these frequency components at its local simulation point.

In some embodiments, the aₖ coefficients can be implemented using complex values rather than real values. In this case, a coefficient can be expressed as:

$${a}_{k} = {a}_{k , r} + i {a}_{k , i} \qquad ( 6.2 )$$

where a_{k,r} and a_{k,i} are the real and imaginary components, respectively. These components together define both the amplitude and phase offset of a frequency component:

$${a}_{k} = \vert {a}_{k} \vert {e}^{i {ϕ}_{k}} \qquad ( 6.3 )$$

where

$$\vert {a}_{k} \vert = \sqrt{{a}_{k , r}^{2} + {a}_{k , i}^{2}}$$

is the magnitude and φₖ=arctan(a_{k,i}/a_{k,r}) is the phase offset.

With complex coefficients, the phase-amplitude vector becomes:

$$B = {\sum }_{k = 0}^{K} {a}_{k} {j}_{k} = {\sum }_{k = 0}^{K} \vert {a}_{k} \vert {e}^{i {φ}_{k}} {j}_{k} \qquad ( 6.4 )$$

When considering time evolution, if we include the temporal dependence in the basis functions, we get:

$$B ( t ) = {\sum }_{k = 0}^{K} \vert {a}_{k} \vert {e}^{i ( 2 π \cdot f ( k ) \cdot t + {φ}_{k} )} \qquad ( 6.5 )$$

Equation 6.5 provides a more general formulation that allows the simulation system to represent states with arbitrary initial phase relationships between frequency components (through the φₖ terms), which can facilitate modeling quantum interference effects and other phase-dependent phenomena. The phase-amplitude vector structure supports both linear and nonlinear physical processes through vector-coupling operations that are appropriate for the mode types undergoing the coupling, which facilitates simulating complex physical systems that exhibit scale-dependent nonlinearity.

This phase-amplitude vector representation provides a unified approach to simulating wave phenomena at a simulation point across multiple physical domains and scales, by encoding both amplitude and phase information in a structured way, through complex coefficients. The simulation system can instantiate, at each point in a CAD model, a different phase-amplitude vector for each different phenomena being tracked at that point, such as for particle states, electromagnetic fields, mechanical vibrations, and other physical phenomena. Each vector represents how values for a corresponding mode may evolve over time at that point. This evolution isn't determined in isolation, but rather emerges from the point's ongoing interactions with the CAD model's broader system, through a chain of local vector couplings.

When adjacent points undergo vector coupling, they exchange information about their respective oscillatory states. This information then propagates further as these points interact with their other adjacent neighbors, creating a network of influence that extends throughout the entire model. Over time, a phase-amplitude vector at a simulation point accumulates frequency information that has traveled from distant regions of the model, allowing that vector to “learn” about the harmonics imposed by the broader system, despite only directly interacting with itself, and with other vectors within the simulation point or its adjacent neighbors.

We can calculate a point's current or future value using:

$$B ( t ) = {\sum }_{k = 0}^{K} {a}_{k} {j}_{k , t} = \vert {a}_{0} \vert + {\sum }_{k = 1}^{K} \vert {a}_{k} \vert {e}^{i ( 2 π \cdot f ( k ) \cdot t + {φ}_{k} )} \qquad ( 6.6 )$$

where a₀ is the amplitude coefficient for the DC component. Equation 6.6 represents how a point may evolve based on its current frequency components, absent any new interactions. This framework can naturally account for non-local effects: when points interact through local vector coupling, as they modify each other's present and future states based on the accumulated wave information that each has received via cascaded coupling operations from throughout the system. For a 3-dimension (3D) CAD model, the point may include a phase-amplitude vector for each {x, y, z} dimension for 3D modes, and the system may evolve each vector based on vector couplings along its corresponding dimension. This creates a computational framework where the simulation system can derive global behaviors organically from local phase-amplitude vector couplings across one or more space dimensions.

### Non-Linear Frequency Mapping

In some embodiments, the simulation system may use a mapping function to map an array index (e.g., an integer, p) to a frequency component of the phase-amplitude vector (e.g., a k value, which may be an integer or a real number). The mapping function may be linear, where the k value may be the same or a multiple of the array index p used to access the frequency component.

Alternatively, the mapping function may be non-linear, where a component index may map to a corresponding k value via a parabolic, logarithmic, or exponential function. For example, a multiphysics simulation may include fine-grained mesh elements with dimensions and physical modes for the quantum-mechanical scale, and may also include coarse-grained mesh elements with dimensions and physical modes for the continuum scale. The non-linear frequency mapping function could allow the simulation system to represent phenomena spanning many orders of magnitude with a limited number of frequency components. For example, a simulation may use non-linear frequency mapping to concentrate more components at lower frequencies (e.g., corresponding to larger wavelengths) and fewer at higher frequencies (e.g., corresponding to smaller wavelengths), thereby configuring the system to utilize computational resources more efficiently for lower frequencies while maintaining coverage across a wider frequency spectrum of interest. This property allows the simulation system to represent both slow and fast physical processes within a single mathematical structure, capturing both long-range couplings and fine-scale phenomena simultaneously.

FIG. 3C illustrates non-linear frequency mapping function 340 for phase-amplitude vectors in accordance with some embodiments of the present disclosure. Non-linear frequency mapping function 340 demonstrates how a mapping scale S can be configured to implement different mapping strategies for distributing frequency components across the frequency spectrum. This diagram in FIG. 3C shows a specific example with K=16 frequency components, and compares different mapping approaches to frequency distribution.

The horizontal axis 342 on the FIG. 3C diagram includes a component index p (ranging from 0 to K), the left-side vertical axis 343 shows the effective frequency component indices k_{eff} (also ranging from 0 to K), and the right-side vertical axis 344 shows the corresponding complex basis functions j_{k_eff} that align with the k_{eff} values.

The diagram illustrates three distinct mapping functions as examples for various S configurations. Curve 347 shows how a mapping scale S=1.0 can create a linear mapping, which distributes frequency components uniformly across component indices p. Curve 346 shows how a mapping scale S>1.0 (e.g., S=e≈2.718) can allocate more frequency components to higher frequencies, with exponentially increasing spacing at higher frequencies. As a further example, curve 348 shows how a mapping scale S<1.0 can allocate more frequency components to lower frequencies.

The simulation system can use the scaling factor to compute a normalized value that spans the range [0,1] (when p∈[0, K]):

$${normalized\_k}_{eff} = {( \frac{p}{K} )}^{S} \qquad ( 7 )$$

The simulation system can compute non-linear frequency mapping from an array index p to the equivalent k_{eff} value by multiplying the normalized_k_{eff} value by K to produce values in the range [0, K], as shown in the scaling function k_{eff}(p):

$${k}_{eff} ( p ) = K \cdot {( \frac{p}{K} )}^{S} \qquad ( 8 )$$

In a frequency-primary configuration, the simulation system can use the scaling function k_{eff}(p) to compute a scaled frequency for an array index p using:

$$f ( p ) = {F}_{max} \frac{{k}_{eff} ( p )}{K} = {F}_{max} {( \frac{p}{K} )}^{S} \qquad ( 9.1 )$$

where Fₘₐₓ is the max frequency of the phase-amplitude vector. In a wavelength-primary configuration, the simulation system can use the scaling function k_{eff}(p) to compute a scaled frequency for an array index p using:

$$f ( p ) = {v}_{k} \cdot \frac{{k}_{eff} ( p )}{{L}_{max}} = {v}_{k} \cdot \frac{K}{{L}_{max}} {( \frac{p}{K} )}^{S} \qquad ( 9.2 )$$

where Lₘₐₓ is the max wavelength of the phase-amplitude vector.

In some embodiments, the simulation system can use the non-linear frequency mapping to efficiently allocate computational resources to frequency ranges relevant for quantum and continuum scales in one vector. This unification eliminates artificial scale boundaries that plague conventional multi-scale simulations, thus allowing seamless transitions between quantum, molecular, and/or continuum regimes.

In a frequency-primary configuration, the simulation system can use the scaling function k_{eff}(p) to compute a scaled frequency for an array index p, based on equation (3), using:

$$λ ( k ) = \frac{{v}_{k}}{{F}_{max}} \cdot \frac{K}{{k}_{eff} ( p )} = \frac{{v}_{k}}{{F}_{max}} \cdot {( \frac{p}{K} )}^{- S} \qquad ( 10.1 )$$

In a wavelength-primary configuration, the simulation system can use the scaling function k(p) to compute the scaled wavelength value for an array index p, based on equation (2), using:

$$λ ( p ) = \frac{{L}_{max}}{{k}_{eff} ( p )} = \frac{{L}_{max}}{K} \cdot {( \frac{p}{K} )}^{- S} \qquad ( 10.2 )$$

These relationships ensure that wavelengths span from the max wavelength Lₘₐₓ (for the lowest non-zero frequency component) down to Lₘₐₓ/K (for the highest frequency component), but with a non-linear distribution that allocates resolution where it provides the most physical insight.

The specific choice of the mapping scale parameter, S, can be tailored to the physical system being simulated. In some embodiments, the user can specify the mapping scale parameter S in a simulation configuration, or as an attribute associated with a mesh physical name. Alternatively, the simulation system may fine-tune the mapping scale parameter S for a vector-coupling computation's output phase-amplitude vector based on the amplitude distributions or frequency distributions of phase-amplitude vector(s) undergoing the vector-coupling operation.

For physical systems with important features across many scales, a mapping scale closer to S=1.0 might be preferred. For systems where low-frequency phenomena dominate, a mapping scale value of S<1 can be tuned to cover more frequency components at those lower frequencies (e.g., S=1/e). Conversely, for systems where high-frequency phenomena are more important, a mapping scale value of S>1 can be tuned to cover more components to those higher frequencies, such as S=e (approximately 2.718).

In some alternative embodiments, the simulation system may implement the scaling function k_{eff}(p) to concentrate a phase-amplitude vector's frequency components to a confined frequency range, [Fₘᵢₙ, Fₘₐₓ], or a confined wavelength range, [Lₘᵢₙ, Lₘₐₓ]. The simulation system may configure a phase-amplitude vector to store kₘᵢₙ and kₘₐₓ for the k-range [kₘᵢₙ, kₘₐₓ] that correspond to the frequency-range attributes [Fₘᵢₙ, Fₘₐₓ] for a vector in a frequency-primary configuration, or correspond to the wavelength-range attributes [Lₘᵢₙ, Lₘₐₓ] for a vector in a wavelength-primary configuration.

The simulation system can implement the scaling function k_{eff}(p) using a range-based function that enforces the confined frequency range, [Fₘᵢₙ, Fₘₐₓ], or the confined wavelength range, [Lₘᵢₙ, Lₘₐₓ]. The range-based function can be a linear function, a parabolic function, a Logistic function, a hyperbolic tangent, an Arctangent function, or any other function now known or later developed that can enforce a minimum and a maximum value. For example, the simulation system may utilize a modified version of the scaling function from equation (8) that enforces the range [kₘᵢₙ, kₘₐₓ]:

$${k}_{eff} ( p ) = {k}_{min} + ( {k}_{max} - {k}_{min} ) \cdot {( \frac{p}{K} )}^{S} \qquad ( 11.1 )$$

Alternatively, the simulation system can implement the scaling function k(p) using the mapping scale parameter, S, to adjust the slope of a sigmoid function σ using:

$${k}_{eff} ( p ) = {k}_{min} + ( {k}_{max} - {k}_{min} ) \cdot σ ( rS ( \frac{2 p}{K} - 1 ) ) \qquad ( 11.2 )$$

where ‘r’ is a tunable parameter that can be configured to ensure good utilization of the sigmoid's dynamic range, such as r=6.

The simulation system can modify equations (9) and (10) to use the range-based scaling function k_{eff}(p), such as the scaling function in equation (11.1) or (11.2), to effectively zoom into a subset of the frequencies (or wavelengths) that correspond to the desired confined frequency range, [Fₘᵢₙ, Fₘₐₓ] (or confined wavelength range, [Lₘᵢₙ, Lₘₐₓ]).

Phase-Amplitude Vector with Explicit Frequency Values

In some embodiments, the simulation system can use phase-amplitude vectors with explicit frequency entries to implement adaptive simulations where frequency resolution requirements vary across mesh elements, or vary as a mode's local state evolves over time. Explicit frequency entries can allow the simulation system to dynamically adjust the frequency distribution to frequency bands of interest, which may change as the simulation evolves.

FIG. 3D illustrates an alternative data structure for a phase-amplitude vector 350 in accordance with some embodiments of the present disclosure. Specifically, phase-amplitude vector 350 can include array entries with explicit frequency values rather than implicit frequency values for array indices. This representation provides greater flexibility for adaptive simulations and enables more efficient memory utilization for systems with sparse frequency content. The structure in phase-amplitude vector 350 can be memory-efficient for systems with sparse frequency content, by storing at each mesh element only frequency components that provide the most meaning to the simulation. Rather than allocating memory for a fixed number of K frequency components at predetermined k integer indices, the explicit representation stores only the frequency components that contribute significantly to the physical state.

Phase-amplitude vector 350 can include a header section 352, which may contain metadata about the vector. Vector header 352 can include a Max Frequency (Fₘₐₓ) field 353 that defines the maximum frequency represented by the vector, a Max Wavelength (Lₘₐₓ) field 354 that defines the maximum physical scale represented by the vector, a Characteristic Timescale (τ) field 355 that defines the natural time evolution scale, a component-specific wave velocity function (vₖ) 356 that defines the wave speed in a medium for a component k, and a Number of Components field 358 that indicates how many frequency-amplitude pairs are stored in the vector.

Phase-amplitude vector 350 can also include a frequency component array 360, which can include a sparse “k” value column 364 that can store the index to a complex-basis function as a real number (not limited to integers), and Amplitude Value column 366 which can store a complex-valued or real-valued amplitude coefficient for each frequency component. The “p Index” column 362 indicates a unique index for each explicit component's array location.

In some embodiments, frequency component array 360 may also include a frequency-value column 368 that can store a frequency for each frequency component, and/or may also include a wavelength-value column 370 that can specify the wavelength for each frequency component. For example, the simulation system may pre-compute the frequency and/or wavelength values for each frequency component based on equations (1)-(4) (as described above in association with FIGS. 3B and 3C), and may store these values into Frequency Component Array 360. Storing the pre-computed wavelength and/or frequency values in array 360 can facilitate reading or writing to an amplitude value that corresponds to a frequency or wavelength value, without requiring the simulation system to first convert the frequency or wavelength value to the corresponding “k” value.

The example entries in array 360 show how the system can dynamically place frequency components at arbitrary points in the frequency spectrum. Component 372 (at array index 0) has k=0.0 representing the DC component with an amplitude coefficient of 0.45. Components 374-380 (at array indices 1-4) have amplitude coefficients for arbitrary k values. This arrangement demonstrates how the system can dynamically assign non-integer values of k to frequency components to better capture the specific frequency content of the physical system being simulated.

In some embodiments, frequency component array 360 may designate k Value column 364, Amplitude column 366, or Frequency column 368 as a query column, and may sort array 360 based on the query column. The simulation system can use a binary-heap search algorithm to efficiently search array 360 for a nearest component entry to the query value (corresponding to the sorted query column) in a log(n) time complexity for a single-threaded process. This binary-search approach enables the simulation system to rapidly update an amplitude coefficient for a component whose query-column value (e.g., a k-value) is closest to the query value, which the system may perform often during the vector coupling operations. If array 360 does not include a component whose query-column value is within a predetermined distance from the query value, the simulation system may create a new entry (e.g., if an empty entry exists), or may replace a frequency component whose amplitude coefficient's magnitude is smaller than the incoming amplitude magnitude.

The simulation system can use the explicit frequency representation to allow frequency components to reside at arbitrary points in the frequency spectrum. The frequency parameter k can be any real number between 0 and K, rather than being constrained to integer values. This flexibility can enable a more accurate representation of physical systems with specific resonances or characteristic frequencies that don't align with fixed indices. For example, the simulation system can adapt the frequency-component entries so that the explicit k, frequency, or wavelength values correspond to specific frequency bands of interest for a particular material or physical process. For materials with sharp resonances or characteristic frequencies, the simulation system may configure array 360 so that the components' k, frequency, or wavelength values capture these features without requiring a high resolution across the entire spectrum.

The mathematical formulation for phase-amplitude vector 350 with explicit frequency components can be expressed as:

$$B ( t ) = {\sum }_{p = 0}^{n} {a}_{p} exp ( i 2 π f ( p ) t ) \qquad ( 12 )$$

where:
B is the phase-amplitude vector;
p indexes the components in the array;
aₚ is the amplitude coefficient (which may be real or complex) at array position p;
f(p) is the explicit frequency stored at or computed from values array position p; and
n is the number of frequency components used (variable, not fixed at K), where n=0 corresponds to the DC component.

The mapping between explicit frequency parameters and wavelength values follows the same principles as the fixed-index representation, using equations (1)-(4).

In some embodiments, the system may implement array 360 as a min-heap sorted by the amplitude coefficient magnitudes. Also, the system may implement the frequency coefficient entries as tuples that include an amplitude coefficient and one or more of: a k-value, a frequency, or a wavelength. This implementation allows the system to easily insert frequency coefficient entries into the heap by replacing the min-valued root, thereby enabling the system to maintain the top K frequencies with the largest amplitudes. The min-heap approach can adapt a phase-amplitude vector's frequency components during simulations, which allows the simulation system to constrain the number of components to manage computational resources.

During a simulation's coupling process, the simulation system may perform the insertion process for a new frequency coefficient entry into a min-heap implementation as follows:
If the heap contains an entry whose frequency is within a predetermined distance to the target frequency, the system can update the matching entry based on the new frequency coefficient entry, and may maintain the heap property around the amplitude values through standard heap operations. During the entry-update operation, the system may replace the amplitude value, or may accumulate the incoming amplitude to the stored amplitude value.
Otherwise, if the heap is not full (e.g., contains fewer than K components), the system can insert the new frequency coefficient entry, and can maintain the heap property around the amplitude values through standard heap operations.
Otherwise, if the heap is full, the system may compare the new frequency coefficient entry's amplitude magnitude with the minimum amplitude magnitude in the heap (e.g., the heap's root). If the new amplitude magnitude is larger than the minimum, the system may replace the heap's root with the new frequency coefficient entry, and may reorganize the heap to maintain the heap property around the heap's amplitude values. On the other hand, if the new amplitude magnitude is smaller than the minimum, the system may discard the new frequency coefficient entry as it does not rank among the K most significant components.

In some embodiments, the simulation system may utilize small phase-amplitude vectors with N explicit frequency values (as described above with regards to vector 350 in FIG. 3D) to store the state information for physical phenomena at simulation points across the mesh. The system may read from these smaller vectors for the vector coupling process, and may utilize large phase-amplitude vector(s) 300 (e.g., as described above with regards to FIGS. 3A-3C) in GPU shared memory as a temporary output during the vector coupling operation. The size for the smaller phase-amplitude vector(s) may be chosen so that they are sufficiently large to store the frequencies that are key to the modes' evolution (e.g., vectors with N=16, 32, or 64 components). The larger temporary output vectors, for example, may include more components (e.g., 128, 256, 512, 1024, or 2048 components), and may implement a linear or non-linear frequency-mapping function (e.g., as described above with regards to FIGS. 3A-3C).

The simulation system can copy the smaller vector(s) to shared GPU shared memory for the vector coupling operation, and can accumulate the coupling results into the larger phase-amplitude vector(s) in GPU shared memory via the direct frequency-mapping functions. The system can perform the vector coupling operation within a GPU thread block, by reading and writing to the GPU shared memory that is local to the GPU thread block, without using GPU global memory during the vector-coupling process. Note that using the smaller phase-amplitude vectors with explicit (sparse) frequency values allows the system to conserve memory space for the full CAD model (e.g., by storing 32 components instead of 1024 components per vector, thereby resulting in a 32× reduction in component entries).

Moreover, using these smaller vectors also allows the system to reduce the computation complexity of the vector coupling process by focusing on only the key frequencies of the input spectrum: if the key frequencies are stored explicitly in a vector with 32 components instead of spread throughout a larger vector with 1024 components, then a 2^{nd} order frequency-mixing process that iterates across two input vectors would need to process only 1024 frequency coefficient entries instead of 1,048,576 frequency coefficient entries, thereby resulting in a 1024× performance improvement.

Once the system completes the vector coupling operation to accumulate the results onto the larger temporary vectors, the system can reset the smaller vectors' min-heaps, and may insert the components from the larger temporary vector(s) in GPU shared memory to the smaller vector(s) in GPU shared memory via a min-heap insertion algorithm. The min-heap insertion algorithm drops entries with the lowest amplitude values, so that only the components with the top N amplitudes remain. After the insertion process, the system may sort the smaller vector(s) in GPU shared memory, so that the component frequency values or k values are sorted incrementally. The system may conclude the vector coupling process by copying the smaller phase-amplitude vector(s) from GPU shared memory onto their corresponding locations in GPU global memory.

### Vector Coupling Process

In some embodiments, the multiple frequency components of the phase-amplitude vector naturally represent multiple physical phenomena across multiple wavelength scales, where each frequency component may represent an accumulation of system-wide couplings at a corresponding energy level. Hence, the vector's core attributes (e.g., frequency Fₘₐₓ or wavelength Lₘₐₓ) and number of frequency components K can be configured to tune how the simulation system models long-range interactions at each local phase-amplitude vector. A smaller “max frequency” Fₘₐₓ or a longer max-wavelength Lₘₐₓ can allow phase-amplitude vectors to track lower-frequency components, whereas a larger number of frequency components K can increase the highest frequency (and the number of frequencies) that can be tracked by a phase-amplitude vector.

This multi-scale representation enables the simulation system to implicitly account for extended spatial correlations, such as quantum entanglement effects, without requiring explicit pairwise calculations between distant mesh elements. For example, unlike typical quantum mechanics simulators (e.g., density functional theory (DFT) simulator), the simulation system of the present disclosure does not need to evolve a local mesh element's state across non-local (e.g., distant, not adjacent) elements in order for the local element's state evolution to account for long-range phenomena. By evolving each phase-amplitude vector through coupling operations with the local element or its adjacent neighbors, the system propagates long-range interaction phenomena that is encoded in the local vectors through a cascade of local vector couplings. This approach substantially reduces computational complexity compared to traditional methods for open quantum systems, such as the Lindblad master equation, whose local and non-local interactions typically scale as O(N²) for a system with N components. The phase-amplitude vector formulation of the present disclosure thus provides a computationally efficient framework for simulating quantum systems via local vector-coupling operations that capture the essential physics of long-range correlations.

The vector-coupling operations between two phase-amplitude vectors are inherently bidirectional, ensuring that energy and amplitude contributions flow in both directions between interacting phase-amplitude vectors. For cross-element coupling operations between two vectors A and B, the system can simultaneously compute amplitude contributions from vector A to vector B and from vector B to vector A, where both vectors undergo updates based on their mutual interaction. This bidirectional approach maintains physical reciprocity and ensures that energy conservation laws are satisfied across the coupling interface. The system can implement this bidirectional coupling by utilizing a separate temporary output vector for each input vector during the coupling computation, which can prevent race conditions while also allowing concurrent updates. The magnitude and direction of these bidirectional contributions depend on the frequency content and amplitude distributions of both vectors, with the coupling strength determined by material properties and geometric factors at the interaction interface.

The system can scale the amplitude contributions generated during vector-coupling operations according to the geometric properties of the mesh elements involved, which can ensure that the simulation maintains physical accuracy regardless of mesh discretization. For same-element interactions, the coupling strength is proportional to the element's volume (in 3D simulations) or area (in 2D simulations), reflecting the physical principle that larger regions support more extensive internal interactions. For cross-element coupling operations, the system can scale the coupling contributions based on the area of the shared boundary between adjacent elements, using geometric scaling that can be computed as a percentage of each element's total surface area:

$${C}_{geo} = \frac{{A}_{shared}}{{A}_{total}} \times {V}_{scale} \qquad ( 13 )$$

where C_{geo} is the geometric coupling factor, A_{shared} is the area of the shared boundary, Aₜₒₜₐₗ is the total surface area of the element, and V_{scale} is a volume-based scaling factor. This approach can ensure that elements with larger contact areas experience stronger coupling, while maintaining mesh-independent results that accurately represent the continuous physical processes occurring in the real system being modeled.

In some embodiments, V_{scale} is a volume-based scaling factor that adjusts coupling strength proportionally to the mesh element sizes involved, which can give larger elements a stronger interaction while maintaining physically consistent results regardless of mesh discretization. The simulation system can, for example, compute V_{scale} as the ratio of the mesh element's volume (or area in 2D) to a reference volume derived from the phase-amplitude vector's max wavelength, and may compute V_{scale} for cross-element interactions as a geometric mean of both interacting elements' volumes.

The simulation system can also generate dynamic coupling rates between phase-amplitude vectors based on their characteristic timescales, spatial separation, and interface geometry to maintain consistent physical behavior across different mesh structures. In some embodiments, the system can compute the effective coupling rate using:

$${R}_{eff} = \frac{Δ t}{τ} \times \frac{{d}_{ref}}{{d}_{actual}} \times {C}_{geo} \times {M}_{coupling} \qquad ( 14 )$$

where R_{eff} is the effective coupling rate, Δt/τ is the timestep-to-timescale ratio, d_{ref}/d_{actual} is the ratio of reference distance to actual element separation, C_{geo} is the geometric coupling factor from equation (13), and M_{coupling} represents material-specific coupling parameters. This rate adjustment ensures that energy transfer and wave propagation occur at physically accurate speeds regardless of the specific mesh resolution or element sizes of the interacting mesh elements or the surrounding elements. The simulation system can apply these adjusted coupling rates to both vectors in a bidirectional coupling operation, which can maintain energy conservation and realistic interaction strengths for vector-coupling operations across the mesh.

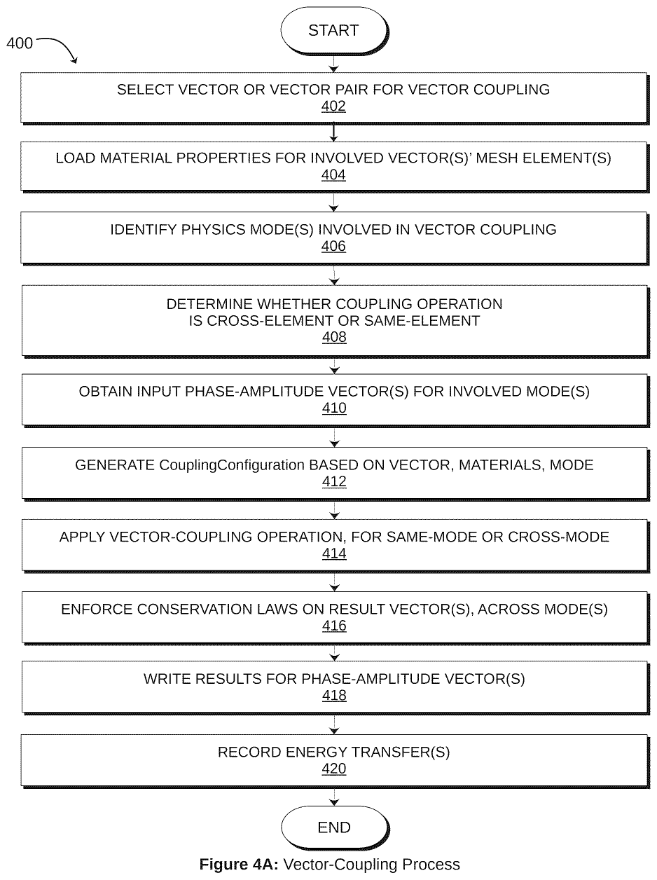

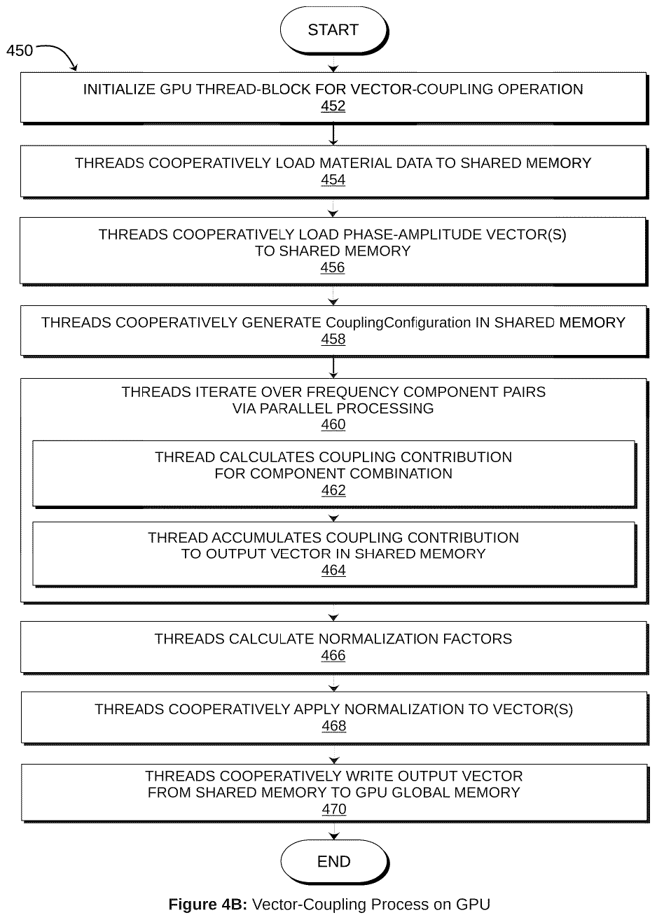

FIG. 4A illustrates a flow chart 400 for a vector coupling process performed by the simulation system to execute vector coupling operations on vectors and vector pairs, in accordance with some embodiments of the present disclosure. This process implements the physical interactions between phase-amplitude vectors that drive the evolution of the simulated system. In some embodiments, when performing a vector-coupling operation on a single input phase-amplitude vector or between two input phase-amplitude vectors, the simulation system avoids race conditions between computation threads by first accumulating the vector-coupling contributions into temporary output phase-amplitude vector(s) while treating the input vector(s) as read-only during computation, and then updating the input vector(s) to incorporate the contributions from the temporary output vector(s) after the vector-coupling operation completes. For cross-mode and cross-element coupling operations involving two input vectors, the system updates both input vectors based on their computed interaction, using separate temporary output vectors for each input vector to ensure race-free computation.

The coupling process can begin by initializing a scratch space in memory for performing the vector coupling operations, and selecting a vector or an vector pair that is to undergo vector coupling (step 402). In GPU-based implementations, the scratch space may be allocated in GPU shared memory that is local to a GPU thread block that is performing the vector coupling process, for faster data access during computation. The system can then load material properties for the involved vector(s)′ mesh element(s), from the material properties database into the scratch space (step 404). The material properties include physical attributes for a material, such as linear and nonlinear response characteristics, coupling strengths, resonance frequencies, and/or other parameters that can govern how physical modes interact within the specific material being simulated.

The simulation system may then identify the physical mode(s) involved in the vector coupling (step 406), based on the simulation configuration and available material data. Different physical modes (e.g., electromagnetic, mechanical, quantum, thermal, etc.) can require a different handling during vector coupling, as they may follow different physical laws and may exhibit different interaction mechanisms. The system identifies the mode(s) to execute the appropriate vector coupling function(s) that apply the correct physical principles to each coupling operation.

For example, the simulation system may implement many versions of a coupling-configuration function, where each version of the function configures a coupling process for a corresponding pair of modes, and the context (e.g., same-mode or cross-mode coupling, same-element or cross-element coupling). The coupling-configuration function can have various coupling processes to choose from, such a frequency-mixing process, an external-field coupling process, a Pauli exclusion process for molecular simulations, etc. Then, when the system is to perform vector coupling between two phase-amplitude vectors (e.g., a vector for a photon mode and a vector for a plasmon mode), the system can select a version of the coupling-configuration function that is customized to the identified mode(s).

The simulation system evolves each mesh element's phase-amplitude vector(s) based on coupling operations with adjacent mesh elements, and can also evolve their vectors based on coupling operations within the same mesh element (e.g., cross-mode interactions and self-interactions). During a respective vector-coupling operation, the system can determine if the coupling operation involves one mesh element (e.g., a same-element interaction) or involves two adjacent elements (e.g., a cross-element interaction) (step 408). These vector-coupling operations may include self-interactions (where a mode interacts with itself), same-mode interactions between adjacent elements, or cross-mode interactions either within an element or between elements. The allowable coupling types depend on the physical configuration of the system (e.g., the modes activated by the user for a mesh element's physical name), and the capabilities of the materials involved.

The system also obtains the input phase-amplitude vector(s) for the involved mode(s) from the simulation data store (step 410), such as by copying the vectors from a GPU global memory or unified memory onto a GPU shared memory region. These vectors represent the current state of the physical modes that are to participate in the coupling operation.

The system can then use a context-relevant coupling-configuration function to initialize a CouplingConfiguration object, that the system may later use to execute a physically accurate vector-coupling operation for the specific interaction context based on the CouplingConfiguration object's parameters. The system can configure the CouplingConfiguration object based on each phase-amplitude vector's attributes (e.g., max wavelength and characteristic timescale), physical mode, and material data for the physical mode (step 412). The CouplingConfiguration specifies coupling parameters including but not limited to a material-response function, coupling strengths, amplitude thresholds, frequency-dependent weights, resonance profiles, and conservation requirements tailored to the specific physical context.

These material-response functions can modify how the individual frequency components participate in the coupling operation based on material-specific properties. For a frequency component f, the material response can be expressed as:

$${a}_{f}^{′} = {a}_{f} \cdot R ( f , M ) \qquad ( 15 )$$

where R(f, M) is the material response function for frequency f in material M. This function can capture phenomena such as frequency-dependent absorption, dispersion, resonance effects, and other material-specific behaviors that can affect how frequency components interact.

In a molecular simulation region, the material-specific properties can correspond to the local molecular region's type, such as atomic nucleus, core shell, or valence shell for points within an atom, or charge-density region for points between atoms. For points within an atom's regions, atomic properties can include effective nuclear charge, ionization energies, screening factors, core binding energies, orbital anisotropy parameters, and hyperfine coupling constants. The molecular simulation regions can also include dynamic properties such as local electron density, charge density distribution, electric potential, temperature, electronegativity, electron localization factors, thermal conductivity, heat capacity, mechanical strain tensors, and shell-specific orbital characteristics.

For a quantum simulation region, the material properties can represent electronic structure properties, collective quantum phenomena, many-body interactions, and spatial correlation properties. Electronic structure properties can include density-of-states functions that determine available electronic states, band structure information that defines electronic energy levels and dispersion relationships, band gaps that set energy scales for electronic excitations, and Fermi energies that establish the electronic chemical potential. Collective quantum phenomena such as collective excitation properties can include plasma frequencies for charge oscillations, frequency-dependent dielectric functions that capture plasmon screening effects, and quantum degeneracy parameters that determine when quantum effects dominate over classical behavior. Many-body interaction properties can include exchange and correlation parameters for electron-electron interactions, magnetic ordering parameters for magnon effects, and resonance enhancement factors that modify coupling strengths at specific frequencies. Spatial correlation properties can include characteristic plasma lengths that define the extent of collective excitations and effective mass factors that account for electron-lattice interactions.

Continuum simulation regions can use material properties that represent macroscopic transport and field phenomena, such as thermal properties, mechanical properties, electromagnetic properties, and dimensional analysis parameters. Thermal properties can include thermal conductivity and heat capacity for temperature-dependent phenomena, along with relaxation timescales that govern thermal equilibration. Mechanical properties can include elastic moduli and yield strengths for structural deformation, fluid viscosity and density for hydrodynamic interactions, and transport coefficients such as diffusion constants and mobility parameters. Electromagnetic properties can include permittivity and permeability for field propagation, along with frequency-dependent response functions for dispersive materials. Dimensional analysis parameters can include Reynolds numbers and Péclet numbers that characterize flow regimes and determine the relative importance of different physical effects.

In some embodiments, during step 412, the system may select a coupling-configuring function that is custom-built for the vector-coupling operation, and custom-built for the same-element or cross-element interaction. The selected coupling-configuring function may further configure the CouplingConfiguration object based on the material properties for the interacting element(s).

Subsequently or combined with step 412, the system can apply the vector-coupling operation for same-mode or cross-mode interactions based on the CouplingConfiguration parameters (step 414). This step executes the mathematical operations that model energy transfer between frequency components of the phase-amplitude vector(s), thereby implementing the physical laws that govern the vector coupling. The vector coupling operations performed in step 414 can include any operations that couples frequency states between one or two vectors, including but not limited to first order self-interactions within one vector, calculating sum and difference frequencies between two vectors, applying material response functions, and implementing thresholds for nonlinear effects.

The system can perform operations 412 and/or 414 within a GPU thread block, which can include reading from and writing to the GPU shared memory that is local to the GPU thread block without using GPU global memory when generating the CouplingConfiguration object, and/or without using GPU global memory when performing the vector coupling operation.

After performing the vector coupling operation, the simulation system can enforce conservation laws on the output phase-amplitude vectors across the mode(s) involved (step 416). The system can select which conservation laws to apply, depending on the physical context. For example, the system can apply energy conservation, via:

$${E}_{total} = {\sum }_{k = 0}^{K} {ω}_{k} {\vert {a}_{k} \vert}^{2} = ” constant ” \qquad ( 16 )$$

where wₖ is the physical frequency corresponding to component k.

As a further example, the system can apply quantum probability conservation, via:

$${P}_{total} = {\sum }_{k = 0}^{K} {\vert {a}_{k} \vert}^{2} = 1 \qquad ( 17 )$$

The simulation system can select which conservation laws to apply to ensure that the simulation maintains physical consistency during its evolution of the phase-amplitude vectors for the various modes across the simulation's mesh elements.

The system may then write the updated phase-amplitude vectors back to the simulation data store (step 418), making the results available for subsequent processing steps or analysis. If the simulation system is running on a GPU, the system may copy the temporary output phase-amplitude vector(s) from GPU shared memory back to their corresponding vector(s) in GPU global memory.

The system may also record energy transfer between mode(s) and/or mesh element(s), along with other metrics of interest (step 420). The system may perform step 420 at the end of a respective vector-coupling operation, or after simulating multiple couplings at a mesh element. These metrics can include:
Energy transfer between different physical modes
Energy distribution across frequency components
Entropy production during the vector coupling
Phase coherence measures for quantum modes
Amplitude distribution changes

In the context of phase-amplitude vectors, entropy quantifies the distribution of energy across frequency components and serves as a measure of thermodynamic irreversibility within the simulated physical system. The statistical entropy of a phase-amplitude vector can be expressed as

$${S}_{ent} = - {k}_{B} {\sum }_{k = 0}^{K} {p}_{k} ln ( {p}_{k} ) ,$$

where k_{B} is Boltzmann's constant, and pₖ=ωₖ|aₖ|²/Eₜₒₜₐₗ represents the probability of finding energy in frequency component k, with the total energy Eₜₒₜₐₗ computed according to equation (16).

During vector coupling operations, entropy typically increases as these operations redistribute energy among frequency components through various physical mechanisms. For example, frequency mixing operations can spread energy across broader frequency spectra through sum and difference frequency generation, while other vector coupling processes such as cross-mode interactions, field coupling operations, or material-specific coupling mechanisms can redistribute energy between different physical modes and/or mesh elements in unique ways. This entropy production captures the fundamental physical principle that local interactions tend to drive systems toward equilibrium by transferring energy from concentrated, ordered states to more dispersed, disordered configurations. In quantum-scale simulations, entropy changes can reflect decoherence processes and the loss of phase relationships between frequency components. In continuum-scale simulations, entropy production can represent classical thermodynamic irreversibility and energy dissipation.

The simulation system's phase-amplitude vectors can track entropy evolution across physical space and time by recording the evolution of the frequency components across vector-coupling operations, which provides insights into energy flow patterns, thermal equilibration rates, and how local interactions drive systems toward equilibrium through energy redistribution. This entropy evolution can be used to analyze the efficiency of energy transfer processes in a simulated system, such as while redesigning the simulated system to reduce the amount of energy that is converted into heat.

### Vector Coupling in a GPU

Recall that the simulation system evolves a simulation by modeling self-interactions within a mode, or modeling cross-interactions between modes and/or between adjacent mesh elements across the simulation space. In a GPU-based computation, a thread block is a group of threads that can execute in parallel and can share resources through fast shared memory that is exclusive to that block. In some embodiments, the simulation system can execute the vector coupling process in a GPU, such as by distributing the set of vector-coupling computations across the available GPU thread-blocks.

For example, each available GPU block may select a unique vector coupling to process, may load the corresponding phase-amplitude vector(s) and material data into its shared memory, and can perform the vector coupling process using GPU shared memory and local thread registers (e.g., without having to utilize GPU global memory other than to read the initial data and store the results). Since shared memory is considerably faster than global memory, this approach significantly reduces the GPU global memory latency bottleneck that often limits computational performance.

FIG. 4B illustrates a flow chart 450 for the GPU thread block execution process performed by the simulation system to parallelize and execute a vector coupling operation on a GPU, in accordance with some embodiments of the present disclosure. This approach leverages the massive parallelism available from one or more GPUs to accelerate the computationally intensive tasks in a multiphysics simulation.

The simulation system may initiate a GPU thread block for the vector coupling operation (step 452). This step may allocate or initialize GPU shared memory, and may assign to the GPU thread block a unique phase-amplitude vector or vector pair for which to simulate a vector coupling. This assignment can be either a phase-amplitude vector pair for cross-element or cross-mode interaction, or a single phase-amplitude vector for self-interaction. The assignment can be determined by a global scheduling mechanism, such as a global variable indicating the next assignment, which distributes work across available GPU resources to maximize parallelism and computational efficiency. The subsequent steps in this process may be performed by the threads in a GPU thread block, as they perform vector coupling for the assigned vector or vector pair.

The threads can cooperatively load material data to shared memory (step 454), where the threads work together to efficiently transfer material properties from GPU global memory or unified memory into faster GPU shared memory. This cooperative loading process can maximize memory bandwidth utilization by utilizing a coalesced memory access pattern. The material data can include parameters such as coupling strengths, frequency-component amplitude thresholds, resonance profiles, and other properties needed for a vector coupling operation, such as frequency mixing.

The threads can also cooperatively load the phase-amplitude vector(s) to shared memory from GPU global memory or GPU unified memory (step 456). The threads can execute step 456 by utilizing a coalesced memory access pattern to copy a phase-amplitude vector 300 with implicit frequency values, or to copy a phase-amplitude vector 350 with explicit frequency values. In either case, this data can include the amplitude coefficients for the frequency components of the vector(s) involved in the coupling operation.

The threads may then cooperatively generate the CouplingConfiguration object in shared memory (step 458), so that the CouplingConfiguration object contains the parameters needed for the vector coupling operation, including coupling strengths, amplitude thresholds, frequency-dependent weights, and conservation requirements. The threads can generate the CouplingConfiguration by leveraging the interaction context (e.g., the mode(s), the element position(s), the material data and vector characteristics, etc.) to configure the coupling operation for the specific physical context.

In some embodiments, the vector coupling algorithm may include one or more nested loops, which the threads in a GPU block may implement by cooperatively iterating over the frequency component combinations in parallel to execute the vector coupling process (step 460). For example, a 1^{st} order frequency-mixing process may iterate across one input vector with K frequency components, whereas a 2^{nd} order mixing process may include two nested vector iterations each with K frequency components. The threads may implement an Nth order mixing process by cooperatively iterating across the frequency component combinations for each of the K^{N} component combinations.

A respective thread may calculate the coupling contribution for a component or component combination that corresponds to its unique loop iteration (step 462), and may accumulate the coupling contribution to a corresponding component in an output vector in shared memory, such as via an atomic memory transaction (step 464). During operation 462, the thread can calculate a coupling contribution for its assigned component combination based on the CouplingConfiguration parameters, where the calculation implements the mathematical operations that model energy transfer between frequency components.

Also, because the vector coupling process may involve two phase-amplitude vectors with non-matching configurations, a k vector index value may represent a different frequency in each of the two vectors. Hence, during operation 462, the thread may perform the sum or difference frequency computations based on physical frequency values that correspond to the k index values, instead of the using the k index values whose meaning may not be the same across the two phase-amplitude vectors. For example, during step 462, the vector coupling process may use an index-to-frequency mapping function (e.g., ƒ=indexToF(k)) to compute the frequencies f₁ and f₂ for components k₁ and k₂, respectively, and can use those frequencies to compute the sum frequencies (fₛ=f₁+f₂) and/or difference frequencies (f_{d}=|f₁−f₂|). Then, when accumulating the sum and/or difference mixing contributions during step 464, the thread may convert the sum and/or difference frequency values (e.g., fₛ and/or f_{d}) to the kₛ or k_{d} index values for corresponding frequency components of the output vector, such as via a function k=ƒToIndex(ƒ) function that computes the k index value based on a phase-amplitude vector's attributes.

In some embodiments, the ƒToIndex(ƒ) function can ensure that computed frequency values are entered into valid frequency component indices by first computing a frequency-wrapped value f′ via:

$${f}^{′} ( f ) = \{ \begin{matrix}\vert f \vert , f \geq - {F}_{max} and f \leq {F}_{max} \\ ( ( f + {F}_{min} ) mod {F}_{max} ) - {F}_{min} , f < - {F}_{max} or f > {F}_{max}\end{matrix} \qquad ( 18 )$$

Notice that equation (18) may use an absolute operator to ensure that frequency values within the range [−Fₘₐₓ, Fₘₐₓ] are mapped to the valid frequency range [0, Fₘₐₓ], which includes allowing frequency-mixing contributions to contribute to the DC component (e.g., f=0 at k=0). Also notice that equation (18) may use a modulo operator to ensure that frequencies which are outside of the range [−Fₘₐₓ, Fₘₐₓ] are wrapped-around to within the range [Fₘᵢₙ, Fₘₐₓ], which does not allow those wrap-around frequencies to contribute to the DC component.

The threads may then cooperatively calculate normalization factors (step 466), and may cooperatively apply the normalization to the vector(s) in parallel (step 468). Applying the normalization to the vector(s) ensures that conservation laws are maintained during the simulation. For energy conservation, the normalization factor could be:

$$scale = \sqrt{\frac{{E}_{before}}{{E}_{after}}} \qquad ( 19 )$$

where E_{before} and E_{after} are the total energies before and after the coupling operation.

The threads may also cooperatively write results from temporary output vectors in GPU shared memory to vector(s) in GPU global memory or GPU unified memory (step 470), thereby transferring the updated frequency components back to the main simulation data store.

In some embodiments, if the vector coupling operation includes frequency mixing, the mathematical structure of the CouplingConfiguration can include parameters for different orders of frequency mixing (e.g., 1^{st} through 4^{th} order), which can be expressed as:

$${a}_{k} ( t + Δ t ) = {a}_{k} ( t ) + \frac{Δ t}{τ} [ ( {\sum }_{n = 1}^{4} Δ {a}_{k}^{( n )} ) - {a}_{k} ( t ) \qquad ( 20 )$$

where:
aₖ (t) is the amplitude of frequency component k at time t;
Δt is the simulation timestep interval;
τ is the characteristic timescale for the vector coupling;

$$Δ {a}_{k}^{( n )}$$

represents the nth-order frequency mixing contribution.

Note that in equation (20), the frequency mixing process implements a change to the current state proportional to the difference between the mixing contributions and the current state, scaled by the factor

$$\frac{Δ t}{τ} .$$

This formulation implements a relaxation toward the steady state, as the mixing operations generate Δaₖ contributions to the k component while simulating vector couplings between physical phenomena. From a physical perspective, the terms inside the square brackets in equation (20) can model how the energy or probability that flows into a frequency component through mixing can be balanced by energy or probability flowing out of that component, thereby maintaining physical consistency during the simulation's evolution.

In some embodiments, the second-order mixing can include the sum frequencies, the difference frequencies, and/or both. The second-order mixing contribution

$$Δ {a}_{k}^{( 2 )}$$

to the k component can be expressed as two nested iterations over the frequency component indices k₁, k₂:

$$Δ {a}_{k}^{( 2 )} = {\sum }_{\begin{matrix}{k}_{1} , {k}_{2} \\ h = fToIndex ( indexToF ( {k}_{1} ) + indexToF ( {k}_{2} ) ) \\ or k = fToIndex ( indexToF ( {k}_{1} ) - indexToF ( {k}_{2} ) )\end{matrix}} {w}_{2} \cdot {a}_{{k}_{1}} ( t ) {a}_{{k}_{2}} ( t ) \qquad ( 21 )$$

where w₂ is the second-order weight derived from material properties, which the system can obtain from the CouplingConfiguration object for use in the frequency-mixing operation.

The higher-order frequency mixing terms extend this pattern to include more complex combinations of frequency components. The third-order mixing contribution can be expressed as three nested iterations over the frequency component indices k₁, k₂, k₃:

$$Δ {a}_{k}^{( 3 )} = {\sum }_{\begin{matrix}{k}_{1} , {k}_{2} , {k}_{3} \\ h = fToIndex ( f ( \begin{matrix}{f}_{1} = indexToF ( {k}_{1} ) , \\ {f}_{2} = indexToF ( {k}_{2} ) , \\ {f}_{3} = indexToF ( {k}_{3} )\end{matrix} ) )\end{matrix}} {w}_{3} \cdot {a}_{{k}_{1}} ( t ) {a}_{{k}_{2}} ( t ) {a}_{{k}_{3}} ( t ) \qquad ( 22 )$$

where f(f₁, f₂, f₃) represents the valid frequency combinations that contribute to component k, including combinations such as (f₁+f₂+f₃), (f₁+f₂−f₃), (k₁−k₂+k₃), and (f₁−f₂−f₃). The simulation system can derive the weight w₃ from third-order material properties (e.g., when generating the CouplingConfiguration object), such as from the third-order susceptibility χ⁽³⁾ in optical materials or from cubic anharmonicity in mechanical systems.

Similarly, the fourth-order mixing contribution incorporates combinations of four frequency components, computed using four nested iterations over the frequency component indices k₁, k₂, k₃, k₄:

$$Δ {a}_{k}^{( 4 )} = {\sum }_{\begin{matrix}{k}_{1} , {k}_{2} , {k}_{3} , {k}_{4} \\ h = fToIndex ( g ( \begin{matrix}{f}_{1} = indexToF ( {k}_{1} ) , \\ {f}_{2} = indexToF ( {k}_{2} ) , \\ {f}_{3} = indexToF ( {k}_{3} ) , \\ {f}_{4} = indexToF ( {k}_{4} )\end{matrix} ) )\end{matrix}} {w}_{4} \cdot {a}_{{k}_{1}} ( t ) {a}_{{k}_{2}} ( t ) {a}_{{k}_{3}} ( t ) {a}_{{k}_{4}} ( t ) \qquad ( 23 )$$

where g(f₁, f₂, f₃, f₄) represents the 16 possible frequency combinations with different sign patterns, such as (f₁+f₂+f₃+f₄), (f₁+f₂+f₃−f₄), etc. The simulation system can derive the weight w₄ from fourth-order material properties (e.g., when generating the CouplingConfiguration object), such as from quartic anharmonicity or from higher-order nonlinear optical effects.

In some embodiments, the simulation system does not need to compute higher-order contributions (e.g., 3rd or 4th order) during the frequency mixing process. Rather, the system may account for up to 1^{st} order contributions when simulating linear systems such as electromagnetic wave propagation in free space, small-amplitude mechanical vibrations in elastic media, or quantum systems in the absence of strong couplings. The system may account for up to 2nd order contributions when simulating moderately nonlinear phenomena such as second-harmonic generation in non-centrosymmetric crystals, parametric amplification in nonlinear optical materials, or anharmonic effects in mechanical systems under moderate strain.

The system can compute higher-order contributions (e.g., 3^{rd} order, or 4^{th} order) to increase the accuracy when modeling complex physical phenomena, such as quantum couplings in strongly correlated electron systems, extreme nonlinear optical effects such as optical Kerr effect in high-intensity laser applications, and highly anharmonic mechanical systems such as materials near phase transitions or under extreme deformation. The system can use these higher-order terms to model threshold-dependent behaviors, such as optical limiting in photonic materials, energy transport in molecular systems, or phase transitions in condensed matter physics, where the response of the system can change qualitatively as the amplitude exceeds certain thresholds.

In some embodiments, the simulation system can implement windowed frequency mixing operations to reduce computational complexity for higher-order frequency mixing processes. The system can implement this windowing approach by partitioning the frequency spectrum of a phase-amplitude vector into a plurality of frequency windows, where a respective window may span over a contiguous range of frequency components. This partitioning enables a frequency-mixing step to operate on representative frequency values for a window rather than running frequency-mixing steps for every individual frequency component of the window, thereby achieving significant computational savings for vectors with large numbers of frequency components. An N^{th} order frequency mixing process that iterates across W windows instead of K individual frequency components would gain a (K/W)^{N} performance improvement. This amounts to a 65,536× performance improvement for a 4^{th} order frequency mixing process that uses 32 windows to span a 512-component phase-amplitude vector.

The system can determine linear window boundaries by dividing the frequency spectrum into windows of equal linear spacing, which provides uniform frequency resolution across the entire spectrum. For a phase-amplitude vector with K frequency components and W windows, the system can calculate linear window boundaries using:

$${w}_{i} = {k}_{min} + i \times \frac{{k}_{max} - {k}_{min}}{W} \qquad ( 24 )$$

where kₘᵢₙ is the minimum frequency index, kₘₐₓ is the maximum frequency index, and wᵢ represents the boundary between window i and window i+1. This linear spacing approach provides straightforward implementation and uniform computational load distribution across the frequency windows.

In some embodiments, the system can alternatively implement logarithmic spacing for window boundaries, which concentrates more resolution at lower frequencies where many physical phenomena exhibit dominant behavior. The logarithmic window boundaries can be calculated using:

$${w}_{i} = {k}_{min} + {( \frac{{k}_{max}}{{k}_{min}} )}^{i / W} \qquad ( 25 )$$

This logarithmic spacing ensures that each window captures approximately the same fractional bandwidth, which aligns with the natural scaling behavior of many physical systems that span multiple orders of magnitude. The system can select between linear and logarithmic spacing based on the spectral characteristics of the physical modes being simulated.

For each frequency window, the system can compute a representative frequency value by calculating a weighted average of frequency values within the window, where the weighting is based on amplitude magnitudes of corresponding frequency components. The representative frequency fᵣₑₚ for window i can be expressed as:

$${f}_{rep , i} = \frac{{\sum }_{k ∈ {window}_{i}} {\vert {a}_{k} \vert}^{2} \times f ( k )}{{\sum }_{k ∈ {window}_{i}} {\vert {a}_{k} \vert}^{2}} \qquad ( 26 )$$

where aₖ is the amplitude coefficient for frequency component k, and f(k) is the frequency value corresponding to component k. This amplitude-weighted approach ensures that the representative frequency reflects the dominant spectral content within each window.

The system also computes a representative amplitude coefficient for each frequency window using a root-mean-square (RMS) calculation to preserve the energy content of the windowed components. The representative amplitude aᵣₑₚ for window i is calculated as:

$${a}_{rep , i} = \sqrt{\frac{{\sum }_{k ∈ {window}_{i}} {\vert {a}_{k} \vert}^{2}}{{N}_{i}}} \qquad ( 27 )$$

where Nᵢ is the number of frequency components within window i. This RMS approach maintains the statistical properties of the original frequency components while reducing the computational burden of the mixing operations.

### Frequency Mixing Operation Execution

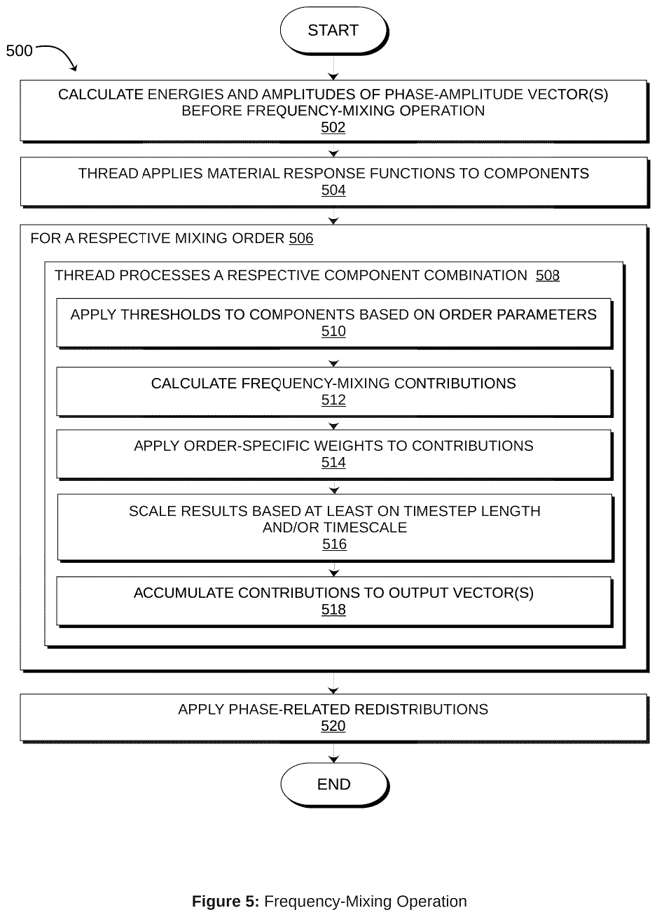

FIG. 5 illustrates a flow chart 500 for a frequency mixing operation performed by the simulation system based on the CouplingConfiguration parameters, in accordance with some embodiments of the present disclosure. This process implements the physical laws that govern how frequency components interact within and between phase-amplitude vectors, based on a CouplingConfiguration object that was generated during step 414 of FIG. 4A or step 458 of FIG. 4B. The CouplingConfiguration object contains the parameters necessary to tailor the frequency-mixing process for a specific coupling context to abide by the physical laws for accuracy, such as by providing one or more of: a material-specific response function, a coupling strength, a component amplitude threshold, phase parameters, diffraction parameters, and a conservation requirement. The simulation system can execute the following steps to perform a frequency-mixing process for vector-coupling step 416 of FIG. 4A, or for vector-coupling step 460 of FIG. 4B.

The simulation system can calculate energies and amplitudes for the involved phase-amplitude vector(s) before performing the frequency mixing to establish baselines for conservation enforcement (step 502). These calculations can include a total amplitude across a vector's frequency components (Aₜₒₜₐₗ) that provides a measure of the overall strength of the represented physical state, and a total physical energy contained in the vector before frequency-mixing (E_{before}):

$${E}_{before} = {\sum }_{k = 0}^{K} {ω}_{k} {\vert {a}_{k} \vert}^{2} \qquad ( 28 )$$

$${A}_{total} = {\sum }_{k = 0}^{K} \vert {a}_{k} \vert \qquad ( 29 )$$

where ωₖ is the physical frequency corresponding to component k, and aₖ is the amplitude coefficient of frequency component k. These pre-mixing values provide reference points that the simulation system may use later to ensure that physical conservation laws are maintained by the frequency mixing process.

In some embodiments, the available threads can cooperatively apply material response functions to frequency components of the input phase-amplitude vector(s) (step 504). To perform frequency-mixing up to an N^{th} order, the simulation system may process contributions for 1^{st} order mixing, and process contributions for 2^{nd} order mixing, etc., up to N^{th} order mixing. First-order effects can represent linear propagation, second-order effects can represent phenomena such as sum and difference frequency generation, third-order effects can represent processes such as four-wave mixing, and fourth-order effects can represent higher-order anharmonic vector couplings.

Hence, for a respective mixing order (e.g., 1^{st} to N^{th}) (step 506), the system may use one or more threads to cooperatively process at least a subset of component combinations. A respective thread may generate and apply contributions for a respective component combination (step 508). For example, the simulation system may stride over a subset of vector components in the outer loop or a nested loop to mitigate the complexity of a high-order mixing process (e.g., by skipping or windowing every 4 components for the 3^{rd} inner loop, and skipping or windowing every 8 components for the 4^{th} inner loop, or by using other user-defined striding or windowing sizes).

The simulation system may process a respective component combination by applying thresholds to the components based on order-specific parameters from the CouplingConfiguration object (step 510). These thresholds can control the activation of nonlinear effects based on amplitude levels, such as to model how nonlinear effects typically require stronger fields or displacements to become significant. In some embodiments, the system can apply the threshold using the order-specific equation for order n:

$${S}_{n} = {T}_{n} ( \frac{A}{{A}_{threshold , n}} ) \qquad ( 30 )$$

where Sₙ is the effective strength for mixing order n, Tₙ is the threshold function (which may be linear, exponential, or another function), A is the relevant amplitude, and A_{threshold,n} is the threshold amplitude for order n.

The system can then calculate frequency mixing contributions for the current order (step 512). These frequency mixing calculations implement the mathematical operations that model energy transfer between frequency components according to physical laws. The frequency mixing calculations can include a combination of sum frequencies and/or difference frequencies, where the specific calculations depend on the mixing order being processed and the CouplingConfiguration parameters.

The system can compute sum frequencies by processing how combinations of frequency components add together, and can compute difference frequencies by processing how combinations of frequency components subtract from each other.

For second-order mixing, the sum frequencies can take the form:

$$Δ {a}_{k}^{( + )} = {w}_{s u m} \cdot {\sum }_{\begin{matrix}{k}_{1} , {k}_{2} \\ k = fToIndex ( ( ( {f}_{1} + {f}_{2} - {f}_{min} ) mod {f}_{max} ) + {f}_{min} )\end{matrix}} {a}_{{k}_{1}} {a}_{{k}_{2}} \qquad ( 31 )$$

where wₛᵤₘ is the sum-frequency weight from the CouplingConfiguration, and where f₁ and f₂ are frequencies corresponding to components k₁ and k₂, respectively. This operation can model physical processes such as sum-frequency generation in nonlinear optics or combination tones in acoustics. When two frequency components add together, they could potentially produce a sum frequency that exceeds the maximum representable frequency fₘₐₓ. The modulo operation (mod fₘₐₓ) wraps this value back into the valid frequency range, implementing a form of frequency aliasing that occurs in discrete physical systems. The modulo operation in equation (31) prevents the sum frequency from wrapping back around to the DC component by first subtracting a minimum frequency fₘᵢₙ to move a non-DC frequency value (f₁+f₂) from the range [fₘᵢₙ, ∞] to the range [0, ∞] prior to applying the modulo fₘₐₓ operation, which produces a modulo result in the range [0, fₘₐₓ). The system then then adds fₘᵢₙ to the modulo result to move the modulo result back to the range between the valid minimum and maximum frequencies (e.g., [fₘᵢₙ, fₘₐₓ]).

For second-order mixing, the difference frequencies can take the form:

$$Δ {a}_{k}^{( - )} = {w}_{diff} \cdot {\sum }_{\begin{matrix}{k}_{1} , {k}_{2} \\ k = fTolndex ( \vert {f}_{1} - {f}_{2} \vert )\end{matrix}} {a}_{{k}_{1}} {a}_{{k}_{2}} \qquad ( 32 )$$

where w_{diff} is the difference-frequency weight from the CouplingConfiguration. This operation can model physical processes, such as difference-frequency generation in nonlinear optics or subtraction tones in acoustics. The absolute value function (|f₁−f₂|) can ensure that the result is always a positive frequency index, as the phase-amplitude vector can only represent positive frequencies. The absolute value implements the physical principle that the energy transfer in difference-frequency generation depends only on the magnitude of the frequency difference, not its sign. Moreover, difference frequencies can be allowed to contribute to the DC component. When the interacting components have the same frequency (e.g., |f₁−f₂|=0), this represents a physical process where two equal-frequency components interact to produce a steady-state (non-oscillating) component.

The system can then apply order-specific weights to the computed contributions (step 514), to give each order of mixing an appropriate strength relative to other orders. The system can derive the weights from material properties and physical constraints during steps 414 and 458 of FIGS. 4A and 4B, and store the weights in the CouplingConfiguration object for use during step 514. For example, in nonlinear optical materials, these weights could correspond to the susceptibility tensors χ⁽¹⁾, χ⁽²⁾, χ⁽³⁾, and so on.

The system can also scale results based at least on the timestep interval and characteristic timescale (Δt/τ) (step 516). This scaling adjusts the rate of frequency mixing to reflect the physical timescales of the system being simulated. The scaling can be expressed as:

$${a}_{k} ( t + Δ t ) = {a}_{k} ( t ) + \frac{Δ t}{τ} Δ {a}_{k} \qquad ( 33 )$$

where Δt is the simulation timestep interval and τ is the characteristic timescale for the coupling operation. This scaling properly allows the system to account for how physical processes evolve over time, with larger timestep intervals or shorter characteristic timescales leading to more substantial changes during each simulation step. In some embodiments, the system can combine steps 514 and 516, such as to generate the order-specific weights during step 514 so that the weights are also scaled according to step 516.

The system can then accumulate the weighted and scaled contributions into the output vector(s) (step 518). This accumulation combines the effects of different mixing orders and frequencies to produce the updated state of the phase-amplitude vector(s). The accumulated contribution for a frequency component k can be expressed as:

$$Δ {a}_{k} = {\sum }_{n = 1}^{4} Δ {a}_{k}^{( n )} \qquad ( 34 )$$

where

$$Δ {a}_{k}^{( n )}$$

is the contribution to frequency component k from mixing order n.

In some embodiments, the simulation system can apply phase-related redistributions to model dispersion effects and phase-dependent phenomena (step 520), if this step is enabled in the CouplingConfiguration object. These redistributions can modify the amplitude distribution based on phase relationships, to implement physical effects such as dispersion, where different frequency components propagate at different speeds. The phase redistribution can be expressed as:

$${a}_{k}^{′} = {a}_{k} + {\sum }_{j \neq k} {T}_{j k} ( ϕ ) \cdot {a}_{j} \qquad ( 35 )$$

where Tⱼₖ(φ) is a transfer function that depends on the phase shift φ, and determines how amplitude from component j redistributes to component k.

The output phase-amplitude vector(s) reflect the physical interactions that occurred during the coupling process, capturing how energy has redistributed across frequency components and between physical modes, according to the material-specific response functions and physical laws implemented in the CouplingConfiguration.

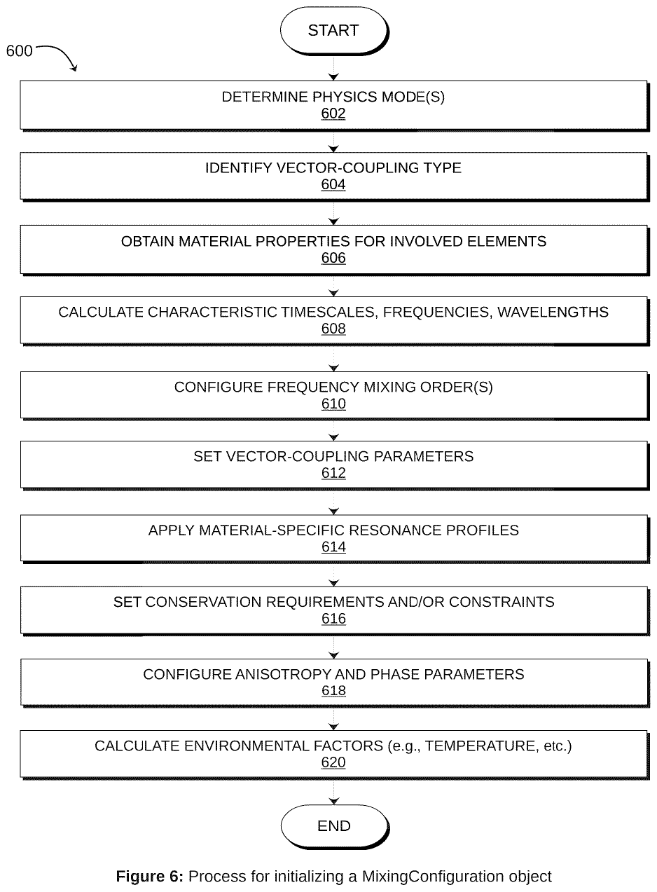

FIG. 6 illustrates a flow chart 600 for a vector-coupling initialization process performed by the simulation system to create the CouplingConfiguration object that governs vector coupling operations, in accordance with some embodiments of the present disclosure. This process translates a vector-coupling context and physical material properties into computational parameters that implement physically accurate material response functions, which the simulation system may use to guide subsequent vector coupling operations. Separating the physical parameterization during the configuration step from the vector-coupling computational implementation allows the simulation system to optimize the implementation for the vector-coupling computational execution without compromising physical accuracy. Moreover, the system can implement a different custom configuration function for each different type of vector coupling, which can facilitate implementing efficient context-specific code that is also easy for software developers to read, test, and validate. This separation enhances both the physical fidelity and computational efficiency of complex multiphysics simulations.

For example, the coupling operation can include one or two phase-amplitude vectors. If the coupling involves two vectors, they may or may not correspond to the same physical mode, and they may or may not correspond to the same mesh element. A different custom configuration function can be implemented for each of the vector combinations that need to be supported by the multiphysics simulation system.

During a simulation step, the system determines the physical mode type(s) of the vector coupling (step 602), such as based on which variable instantiates a phase-amplitude vector, or based on a static or dynamic mode-type variable that is stored inside or alongside the phase-amplitude vector's data structure. The mode type(s) can include physical phenomena that correspond to a specific physics scale, such as a quantum scale, a molecular scale, or a continuum scale. Some physical mode types may span various physics scales, such as photon radiation, electromagnetics, stress, strain, torsion, etc.

The system identifies the vector-coupling type being configured (step 604). The coupling type can be self-interaction (where a phase-amplitude vector interacts with itself), cross-mode interaction (such as for vector coupling between different physical modes, within the same mesh element), cross-region interaction (where vectors in different mesh elements interact, either within the same mode or between different modes). The coupling type determines which physical laws and coupling mechanisms apply to the configuration.

Recall that some physical modes can be specific to a physical scale. In some embodiments, a cross-mode interaction may also be a cross-scale interaction that can implement vector couplings between physics scales, such as to couple quantum and continuum scales for semiconductor photonic devices, or to couple molecular and quantum scales for a molecular nanopore sensing mechanism. These cross-mode and cross-scale vector coupling capabilities eliminate artificial boundaries between physical domains and scales that can limit the performance and accuracy of conventional simulation approaches.

The system also obtains material properties for the mesh elements involved in the vector-coupling operation, such as from a material properties database (step 606). These material properties can include linear and nonlinear response characteristics, resonance frequencies, coupling strengths, and other parameters that define how materials respond to different physical stimuli. For a cross-element interaction at an interface between two different materials, the simulation system can copy material properties for both materials into a shared-memory scratch space, and may combine their material characteristics to derive the interface behavior for the vector coupling.

The system may also calculate characteristic timescales, frequencies, and/or wavelengths for each phase-amplitude vector (step 608). These characteristic values define the spatial and temporal scales for the physical modes involved in the vector coupling operation. The simulator can use these characteristic values to compute the vector's max wavelength Lₘₐₓ that indicates the physical scale represented by the phase-amplitude vector, the max frequency Fₘₐₓ that indicates the highest energy (e.g., corresponding to a minimum wavelength λₘᵢₙ) represented by the phase-amplitude vector, and the characteristic timescale τ that indicates the natural rate of evolution. In some embodiments, the system can obtain the characteristic timescales and lengths from the phase-amplitude vector(s) themselves, which can allow the system to pre-compute the characteristic timescales and lengths, or can allow a researcher to control the timestep interval for a mode's intended phenomena (e.g., for high-frequency phenomena).

In some embodiments, the system can calculate the characteristic timescales and lengths for interacting phase-amplitude vector(s) during step 608, based on material properties, a mesh topology, and a physics scale. The system can store these characteristic timescale and length values in their respective phase-amplitude vector, to achieve adaptive adjustment of simulation timestep intervals as computational demands change. The simulation system may periodically group vector-pair couplings by timestep intervals derived from their characteristic timescales and characteristic lengths, then perform vector coupling more frequently for coupling groups with smaller timestep intervals than for those with larger timestep intervals.

The simulation system computes the timestep interval using the Courant-Friedrichs-Lewy (CFL) condition applied to the highest frequency component in each phase-amplitude vector, ensuring numerical stability while maximizing computational efficiency:

$$Δ t \leq C \cdot \frac{{λ}_{min}}{{v}_{max}} \qquad ( 36.1 )$$

where λₘᵢₙ is the minimum wavelength in the phase-amplitude vector, and vₘₐₓ is the maximum wave velocity across the vector's set of frequency components (e.g., computed via Padé approximants) and C is a dimensionless Courant number typically between 0.1-0.5. This approach enables phase-amplitude vectors to achieve significant computational advantages over traditional methods: the simulation system can discretize a CAD model into a mesh using a much coarser granularity for the mesh elements (e.g., based on Lₘₐₓ rather than λₘᵢₙ) while maintaining fine temporal resolution through frequency domain representation based on λₘᵢₙ, resulting in orders-of-magnitude reduction in total computational cost for multi-scale problems. A user can configure the Courant number C to specify a desired balance between simulation speed and accuracy.

In a wavelength-primary configuration of a phase-amplitude vector with max wavelength Lₘₐₓ and with K frequency components, the stability-limiting wavelength is the minimum wavelength

$${λ}_{min} = \frac{{L}_{max}}{K} ,$$

giving the CFL condition:

$$Δ t \leq C \cdot \frac{{L}_{max}}{K \cdot {v}_{max}} \qquad ( 36.2 )$$

In some embodiments, the system can compute the max frequency, Fₘₐₓ, and the max wavelength, Lₘₐₓ, based on the material properties, a mesh topology, and based on the coupling's physical mode and physics scale. The system can compute component-specific characteristic timescales based on individual frequency component properties. For a phase-amplitude vector in a frequency-primary configuration, the system can compute the timescale from the max frequency using:

$${τ}_{k} = \frac{1}{f ( k )} = \frac{K}{{F}_{max} \cdot k} \qquad ( 37.1 )$$

For frequency component at array index k in a vector operating in a wavelength-primary configuration, the frequency component has wavelength λₖ=Lₘₐₓ/k_{eff}, where k_{eff} may be a scaled index

$${k}_{eff} = K \cdot {( \frac{k}{K} )}^{S} .$$

The system can compute the component-specific timescale using:

$${τ}_{k} = \frac{{λ}_{k}}{{v}_{k}} = \frac{{L}_{max}}{{k}_{eff} \cdot {v}_{k}} \qquad ( 37.2 )$$

where vₖ is the component-specific wave velocity for array index k, computed from the vector's Padé approximant coefficients for the scaled index k_{eff}, which allows accurate representation of dispersion effects. The simulation system may compute the vector's overall timescale τ so that it corresponds to the vector's dominant component timescale, which oftentimes may correspond to a lowest frequency. This overall vector timescale τ effectively configures the vector's update frequency in the multi-scale time integration framework. This frequency-domain approach can naturally capture scale separation efficiently: simulating slow, long-wavelength phenomena at phase-amplitude vectors with low-frequency components and simulating fast, localized dynamics at phase-amplitude vectors with high-frequency components; this scale separation enables automatic computational load balancing where finer timestep granularity is applied toward mesh elements with higher frequency requirements, rather than requiring uniform fine timestep discretization across all phase-amplitude vectors across all mesh elements.

If the vector coupling process involves frequency mixing, the system may also configure the parameters for the various frequency mixing orders (e.g., from 1^{st} to N^{th} order) based on material nonlinearity properties (step 610). Each order can capture order-specific physical effects:
First-order parameters may represent linear propagation, where frequency components may evolve independent from other frequencies.
Second-order parameters can model physics phenomena, such as a sum-frequency and/or difference-frequency generation, corresponding to quadratic nonlinearities in materials.
Third-order parameters can capture physical effects, such as four-wave mixing and self-phase modulation, corresponding to cubic nonlinearities.
Fourth-order parameters can represent higher-order anharmonic effects and complex quantum vector couplings.
   Each order's configuration can include one or more of an amplitude threshold, a threshold function, mixing weights for sum and/or difference frequencies, frequency band selection parameters, and windowing information for performing a coarse windowed traversal across a phase-amplitude vector, and/or any other frequency-mixing configuration attributes now known or later developed.

The system can also set coupling parameters (step 612), such as coupling strengths and threshold values based on material properties and coupling types. For cross-mode interactions, the system can establish mode-specific coupling parameters, which the system can derive from material properties that indicate how different physical modes interact. These coupling parameters can configure the vector-coupling process to implement the physical laws governing mode coupling, such as electron-phonon couplings or photon-phonon scattering.

In some embodiments, the system can apply material-specific resonance profiles to the configuration (step 614). A resonance profile can model frequency-dependent response enhancement near resonant frequencies, which can capture how materials exhibit dramatically different behavior at specific frequencies corresponding to natural resonances. The system may encode a resonance profile into a phase-amplitude vector's component-specific velocity function (e.g., the Padé approximant for the velocity function). For a frequency-mixing process, the system may also apply different resonance profiles separately to each mixing order, which can configure the frequency-mixing process to implement the physical principle that resonances can affect different orders of nonlinearity differently.

The system can also set conservation requirements and/or constraints in the configuration object (step 616), based on the physical modes involved. Different physical modes can require mode-specific conservation laws. For example, the system may apply energy conservation to vector couplings across the set of physical modes at a mesh element, such as to ensure that total energy is preserved during vector couplings. On the other hand, the simulation system may apply normalization to phase-amplitude vectors for quantum modes to ensure that their vectors maintain probability conservation, which may not be necessary for the continuum mode.

In some embodiments, the system can configure anisotropy and phase parameters in the configuration object to model direction-dependent vector couplings (step 618), such as when the coupling involves an anisotropic material. These anisotropy and phase parameters can include a tensor that captures how material responses can vary with direction. The system can also calculate temperature factors and other environmental effects on coupling strengths and amplitude thresholds (step 620).

### Overall System Architecture

In some embodiments, the simulation system may distribute the vector coupling processes across multiple GPUs, on one or more compute nodes. This parallelized implementation of vector couplings allows the simulation system to simulate physical systems that are larger and more complex than would be possible with conventional sequential processing approaches. The distributed-GPU architecture can scale effectively with increasing problem size and complexity. Additional GPUs can be added to the simulation system as the number of mesh elements increases to ensure that computational performance remains efficient.

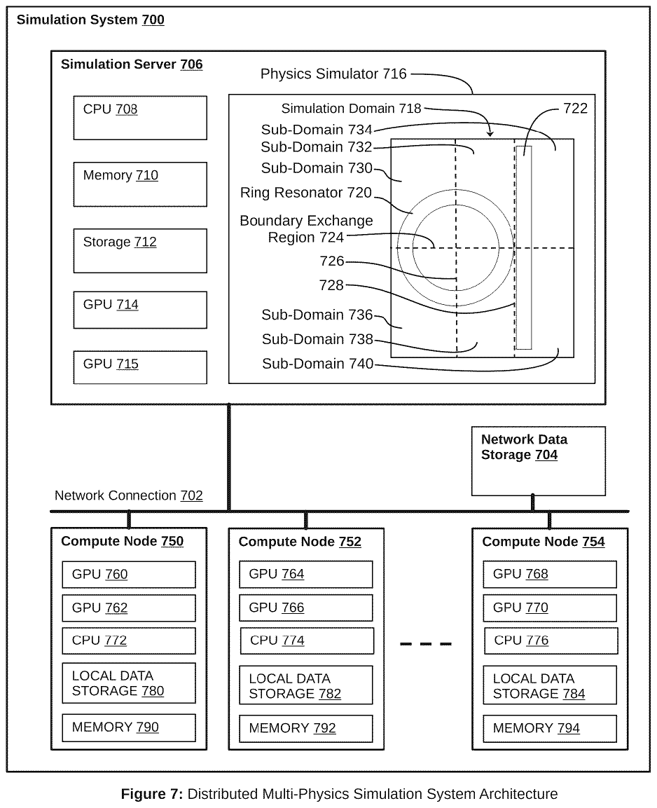

FIG. 7 illustrates a distributed system architecture 700 of the multiphysics simulation system, in accordance with some embodiments of the present disclosure. This architecture demonstrates how the simulation workload can be distributed across multiple computing resources to efficiently handle large-scale physical simulations.

The simulation system 700 can include a high-speed network connection 702 that connects a network data storage 704, a simulation server 706, and compute nodes 750-754 for efficient data exchange. These connections enable the transfer of simulation configurations, material data, simulation data, simulation results, etc. between different components of the distributed system. The network connections may utilize high-bandwidth, low-latency technologies such as InfiniBand, high-speed Ethernet, or any other high-speed interconnects that are now known or later developed.

Network data storage 704 can contain a database and/or a data store for the CAD model and simulation data, providing centralized access for the compute nodes of simulation system 700. The database can include any database that supports transaction queries, which allows multiple database clients to leverage the database to coordinate the state of the simulation with each other. The data store can employ high-performance storage technologies, such as parallel file systems, storage area networks (SANs), or any centralized or distributed file systems that are sufficiently efficient for scientific computing workloads. Simulation server 706 and the various compute nodes 750-754 can use network data storage 704 as a central repository to synchronize their simulation state with each other via the database, and to share boundary simulation data with other compute nodes via the data store.

In some embodiments, simulation server 706 can manage the overall simulation process, including job distribution, result collection, and progress monitoring. Simulation server 706 may assign computational tasks to compute nodes 750-754, may coordinate the activities of compute nodes 750-754, may monitor execution progress, and may collect results for analysis or visualization. Simulation server 706 may also provide a user interface for configuring a simulation, monitoring a simulation's progress, and for visualizing a simulation's real-time or results. In some embodiments, simulation server 706 can include a hypertext transfer protocol (http) server for providing a web-based user interface, via a local network or the Internet, to a web browser on a client computer, which may or may not be the same computer as simulation server 706. Alternatively or in addition, simulation server 706 may include a user interface which is rendered and displayed to a local user via a local graphics processor (e.g., a GPU) connected to a display device.

Compute nodes 750-754 can provide the primary computational resources for executing the vector coupling operations that drive the physical simulation. A compute node can include at least one CPU to coordinate simulation tasks, and can use the at least one CPU and/or one or more GPUs to compute the vector coupling operations in parallel. In some embodiments, compute nodes 750-754 can perform the operations described for simulation server 706 to also serve as simulation servers.

Compute nodes 750-754 can include a local data storage (e.g., local data storage 780 on compute node 750) to store at least a portion of the CAD model and the corresponding simulation data for faster access during the simulation's computations. This local storage can reduce the need for frequent network access by keeping frequently used data close to the computational resources. The local data storage devices can include a high-speed solid-state drive (SSD) or other low-latency storage technologies to minimize data access times.

Compute nodes 750-754 can also include a local memory 790-794 (e.g., memory 790 on compute node 750), which a compute node may utilize as unified memory that is accessible by a local CPU and/or a local GPU. This unified memory region can be substantially larger than that of a GPU's global memory region, which can allow GPUs 760-770 and/or CPUs 772-776 to collaboratively process the vector-coupling computations via distributed vector-coupling processing, and can allow the simulation system to simulate a larger portion of the CAD model than what can fit in any single GPU's global memory.

In some embodiments, compute nodes 750-754 configure a unified memory region that lies primarily on local data storage 780-784 and upon a page miss can get paged onto memory 790-794 and a local GPU. For example, as the simulation progresses on compute node 750, a page miss on a memory region accessed by a simulation on a local GPU 760 may cause that memory region to get accessed from memory 790. If that memory region is not currently stored at memory 790, the memory access would cause a page miss in memory 790, which may cause compute node 750 to access that memory region from local data storage 780 and to page that memory region onto memory 790. Paging the memory region onto memory 790 then allows compute node 750 to resolve the page miss on global memory of GPU 760 by paging that memory region from memory 790 onto global memory of GPU 760.

GPUs 760-770 and CPUs 772-776 distributed across compute nodes 750-754 can provide massive parallel processing capabilities needed for efficient vector coupling operations across a large CAD model with millions of mesh elements. Each GPU may contain thousands of computational cores capable of executing vector coupling operations simultaneously, which can substantially accelerate the simulation compared to a CPU-only simulation. Moreover, processing a subset of the vector coupling operations on CPUs 772-776 can further speed up the simulation by utilizing CPU processing capacity that would otherwise be left unused in a GPU-only simulation.

Simulation server 706 can include instructions that implement a physics simulator 716 for running a physics simulation locally and/or across compute nodes 750-754. Physics simulator 716 can allocate memory or disk space (e.g., in memory 710, storage 712, and/or network data storage 704) that include data for a simulation domain 718 that represents a physical space being simulated, including a mesh for simulation space region (e.g., a 2D or 3D region), phase-amplitude vectors for the physical modes being tracked, simulation configurations, material data, and boundary conditions. For example, the mesh for simulation domain 718 may include mesh data for a ring resonator 720 and a waveguide 722, that together may undergo evanescent vector-coupling operations during an electromagnetics simulation.

Physics simulator 716 can partition simulation domain 718 into one or more sub-domains, and can accelerate the physics simulation by assigning each sub-domain to a different GPU that is either local to simulation server 706 (e.g., GPU 714), or that is accessible at any of compute nodes 750-754. For example, simulation server 706 may assign sub-domains 730-740 to GPUs 760-770, respectively. Each sub-domain can contain a subset of contiguous mesh elements from the complete simulation domain, allowing each GPU to process its assigned elements independently for most operations.

In some embodiments, the CAD model may include surface elements which physics simulator 716 can use as boundary exchange regions 724-728 that together define the mesh regions in sub-domains 730-740. Alternatively, physics simulator 716 can automatically identify substantially optimal boundary exchange regions, that can form sub-domains 730-740 so that achieve a nearly uniform number of mesh-element distribution.

For example, boundary exchange region 724 can represent areas where sub-domains 730-734 interact with sub-domains 736-740, which would require data exchange between GPUs along the mesh elements substantially close to boundary exchange region 724. Simulation system 700 can perform data exchange between GPUs at boundary regions 724-728 to ensure that vector coupling operations correctly account for physical mode couplings that span sub-domain boundaries.

In some embodiments, the architecture for simulation system 700 supports both vertical scaling (more powerful GPUs and CPUs) and horizontal scaling (more compute nodes or GPUs) to handle larger and more complex simulations. Vertical scaling can increase the computational capacity of individual nodes by using more powerful CPUs and GPUs with more cores and memory, while horizontal scaling can add more compute nodes to the system. This flexibility allows simulation system 700 to adapt to different simulation requirements and available hardware resources.

A GPU on a compute node can communicate with other GPUs on the same compute node through high-speed interconnects, and can communicate with GPUs on other compute nodes either directly over network connection 702 and/or indirectly via network data storage 704 (e.g., via the database or a data store on network data storge 704). For example, an intra-node communication can include a high-bandwidth bus architecture (e.g., PCIe) or a specialized GPU interconnect (e.g., NVIDIA NVLink from NVIDIA Corporation), and an inter-node communication can occur over network connection 702.

In some embodiments, simulation system 700 can keep track of which GPUs are available via the database on network data storage 704. Simulation system 700 can select the number of available GPUs and compute node CPUs to reserve by considering both the number of elements and the complexity of material interactions in each sub-domain. This load balancing ensures efficient utilization of the computational resources by assigning work proportionally to the processing capacity of each GPU and each compute node's CPUs, without reserving more GPUs and compute node CPUs than are necessary so that they may be utilized by other physics simulations. The system may estimate the computational complexity of a sub-domain using simulation-domain factors such as material nonlinearity at mesh elements, number of physical modes at mesh elements, and mesh density.

### Overall Simulation Process

The distributed computer system can execute a large-scale multiphysics simulation across distributed computing resources. The simulation server can manage the execution workflow to provide a complete framework that can simulate complex physical phenomena across multiple scales and physics domains. The physics simulator's use of vector coupling on CPUs and/or GPUs to evolve phase-amplitude vectors combines physical accuracy with computational efficiency, leveraging parallel processing and physics domain decomposition to handle simulations that would be intractable with conventional simulators.

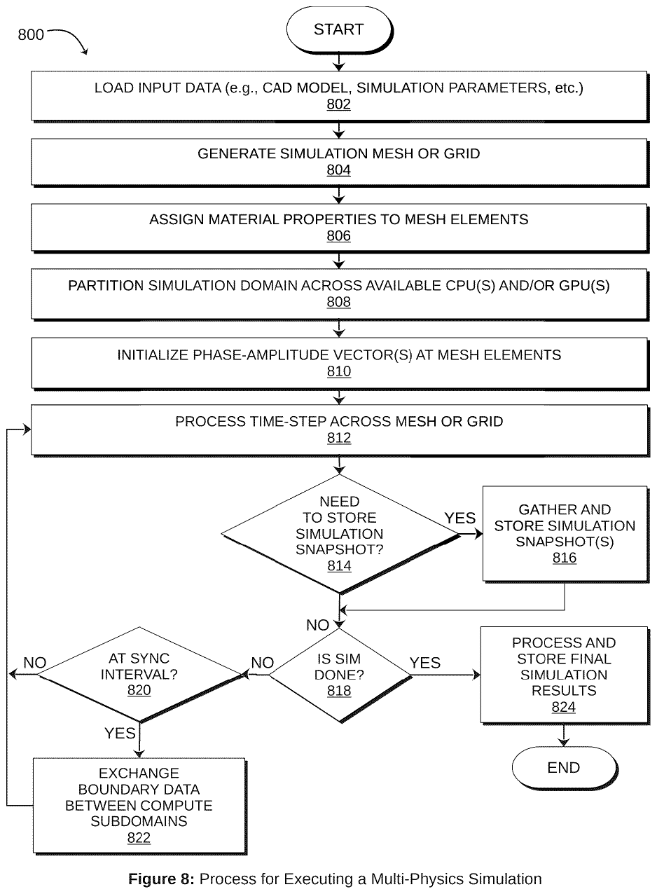

FIG. 8 illustrates a flow chart 800 for a multiphysics simulation process performed by the simulation system using phase-amplitude vectors, in accordance with some embodiments of the present disclosure. Hereinafter, the term “simulation system” or “system” can refer to simulation system 700 of FIG. 7, which can include a simulation server 706 that can execute the process described in flow chart 800, either locally within its own CPUs and/or GPUs (e.g., CPU 708 and/or GPUs 714-715 in simulation server 706), and/or via CPUs and/or GPUs across one or more distributed compute nodes (e.g., compute nodes 750-754).

The simulation system can initiate the computational workflow for simulating physical phenomena, such as by loading from storage any input data that models the physical phenomena (step 802). The input data can include, for example, a CAD model that includes a 2D or 3D description of the physical simulation domain, material properties, simulation parameters, etc. The CAD model can include a mathematical model that defines a spatial domain for the physical system being simulated, such as a point cloud, a solid model, a geometric model, a non-uniform rational basis spline (NURBS) model, etc. The CAD model can also include physical tags for components in the CAD model, which a user can use to assign simulation parameters to regions within the CAD model, such as to specify physical scales for certain CAD model regions (e.g., molecular, quantum, or continuum scales), and to specify which physical modes to activate within these CAD model regions.

Specifically, the material properties can include numerical properties that describe how different materials may respond to physical stimuli within a physical scale, including linear and nonlinear response characteristics. The simulation parameters can specify configuration options, such as which physical scale to assign to a respective mesh physical tag, which material properties to assign to a respective mesh physical tag, which modes to activate for a respective mesh physical tag, a simulation duration, a minimum or maximum timestep interval for a physical scale, a minimum or maximum wavelength for phase-amplitude vectors associated with a physical name, a minimum or maximum characteristic timescale for phase-amplitude vectors associated with a physical name, an output snapshot frequency, mesh physical tags to include in mesh snapshots, etc.

The system can generate a simulation mesh or grid for the simulation (step 804), such as by discretizing the CAD model's representation of a continuous physical space into finite elements that serve as the computational units for the simulation. The mesh generation may use spatial discretization techniques such as tetrahedral or hexahedral meshing for three-dimensional models, with mesh refinement in regions of complex geometry or rapidly varying physical properties. The system can determine the maximum mesh dimensions for mesh elements within a region based on a physical scale assigned to the region and/or physical modes activated in the region. The mesh can include mesh nodes and mesh elements that describe the spatial arrangement of different materials and structures of the simulation domain.

The system may then assign material properties to each mesh element (step 806), based on simulation parameters that map the CAD model's physical tags to their material definitions. A material mapping configuration can include, for example, a physical name, and a material property identifier (e.g., a material name or unique identifier) which references a set of material properties. The simulation system may load the various material properties, such as by reading the material properties from a database and storing them into a global data structure for the CAD model. In some embodiments, the material properties can be stored in an array where the material properties for each material can be referenced via a numeric index or a memory pointer. Then, for each material mapping, the system can search the global material data structure for the mapped material (e.g., by searching for a material by name) to obtain a numeric index or memory pointer, and may store the numeric index or pointer into any mesh element associated with the physical name. Alternatively, the system can store the material properties for a mesh element within a data structure for the mesh element, which can allow a GPU's thread block to load a mesh element's configuration from GPU global memory onto GPU shared memory via a coalesced memory transaction.

The system can partition the simulation domain across available CPU(s) and/or GPU(s) (step 808), such as to balance a computational load across the available CPUs and/or GPUs, and/or to balance the available CPUs and/or GPUs across one or more physics simulations. This partitioning can divide the mesh into subdomains, where each subdomain may be processed by a different compute node or GPU, and allows compute nodes to limit their communication overhead between simulation timesteps to the mesh elements substantially close to subdomain boundaries.

During step 808, a computation node may further partition its subdomain(s) to identify independent vector pairs using a color scheme (e.g., a checkerboard approach) to enable parallel processing within a color group without conflicts or race conditions at a phase-amplitude vector. The coloring approach can prevent race conditions by ensuring that adjacent vector couplings (e.g., couplings that share one phase-amplitude vector) are processed during different simulation timesteps, or by different execution units. Hereinafter, the terms “color group”, “coupling group”, and any variation thereof may be used to describe a group comprising one or more pairs of phase-amplitude vectors where the vector-pair interactions occur at a timestep interval associated with the group.

In some embodiments, the simulation system may further partition the color groups based on the type of vector-coupling operation, such as to further group the vector pairs into groups for: cross-element same-mode couplings, cross-element cross-mode couplings, same-element cross-mode couplings, and self-couplings (e.g., same-element same-mode couplings that involve only one phase-amplitude vector instead of two). The simulation system can, for example, organize its vector-pair coupling operations at a respective simulation timestep to first perform cross-element same-mode couplings, then cross-element cross-mode couplings, then same-element cross-mode couplings, followed by self-couplings.

Note that vectors with widely different timescales may require different update frequencies to maintain stability and accuracy, and updating all phase-amplitude vectors by the highest update frequency may be substantially inefficient. Hence, the system can partition the color groups further to form color timescale groups, by grouping vector pairs in a color group by their characteristic timescale, which can allow the system to efficiently implement multi-scale time stepping. These color groups and color timescale groups allow the system to update vectors with similar characteristic timescales together using the same timestep interval.

The system may then initialize one or more phase-amplitude vectors per mesh element according to initial conditions specified in the simulation parameters (step 810). Once initialized, these phase-amplitude vectors can represent the initial state of different physical modes (electromagnetic, mechanical, thermal, quantum, etc.) at each simulation point in the simulation domain. The system may initialize the vectors by assigning initial local values to the phase-amplitude vectors, such as by assigning DC component values, and optionally assigning certain explicit frequency components at signal sources. Alternatively or additionally, the system can estimate initial frequency component values using analytical functions that compute physical field distributions from static material properties and/or environment data. For example, if the user provides initial environmental attributes for a region of the CAD model (e.g., a temperature), the system may estimate frequency component values for phase-amplitude vectors associated with those environmental attributes (e.g., to initialize phonon mode vectors throughout that mesh region so that the frequency component values correspond to the region's temperature).

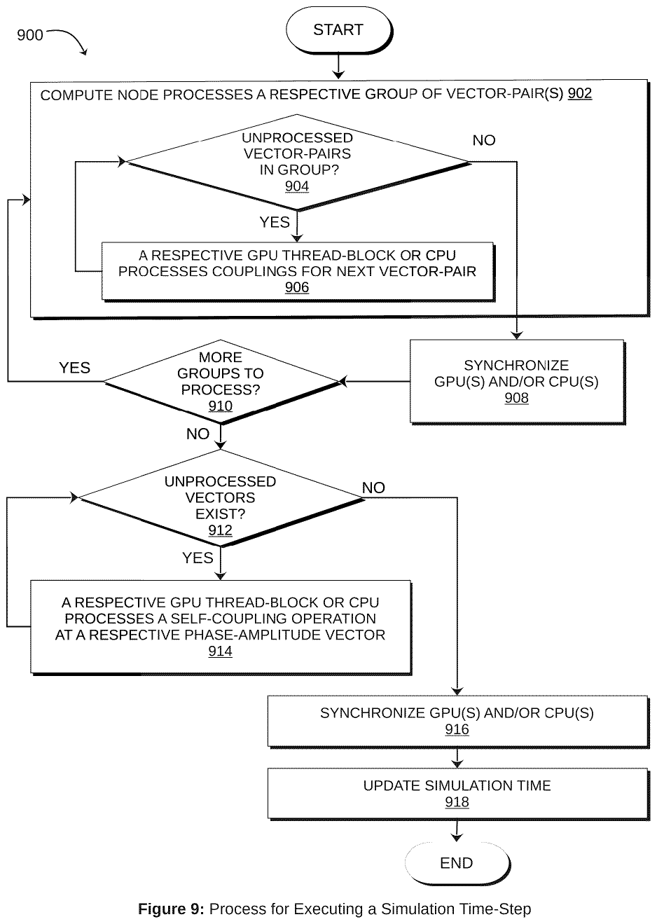

Once the vector pairs have been assigned to color groups at a compute node, the system can process one or more time-steps across each sub-domain's mesh or grid to evolve the full sub-domain toward the next global timestep (step 812), using the checkerboard approach detailed in FIG. 9. For example, if a color group has been broken down to color timescale groups with timestep intervals {2 ns, 20 ns, 100 ns}, the system may simulate the 100 ns group once, the 20 ns group 5 times, and the 2 ns group 50 times (e.g., 10 times for every timestep of the 20 ns group). This process implements the physical interactions that drive the system's evolution, including vector coupling operations within and between phase-amplitude vectors.

In some embodiments, the simulation system can initially perform step 812 within a static-simulation warm-up period that precedes a full dynamic simulation. During this warm-up period, simulation operations in step 812 may estimate runtime intermediate state data (e.g., derived environment data) from static material or static environment data rather than from dynamic local states, since the phase-amplitude vectors may not yet contain complete system-wide harmonic information. This approach enables vector coupling operations to propagate each simulation point's local state information onto the frequency components of phase-amplitude vectors throughout the entire CAD model through a sequence of local vector-coupling operations. The static-simulation warm-up period should be sufficiently long to allow phase-amplitude vectors at individual simulation points to acquire information about the effects that a non-negligible encompassing portion of the simulation domain imposes on that point's local state.

During the static-simulation warm-up period, the system maintains certain model attributes as static (such as mesh node positions) to allow the CAD model's vectors' frequency components to establish system-wide harmonic effects before the simulation system transitions to a dynamic simulation. Once the system completes the static-simulation warm-up period, the simulation system can transition from the static-simulation warm-up period to a dynamic-simulation period either immediately or over an overlapping transition interval. In the dynamic-simulation period, simulation operations in step 812 can derive the runtime intermediate state data from the evolving local states (e.g., from local phase-amplitude vectors whose frequency components carry system-wide harmonic information) rather than computing static estimates. The simulation system also allows updating mesh node positions based on dynamic local states, such as based on phase-amplitude vectors representing phonon, stress, strain, and/or torsion modes.

The system can implement the transition interval from a static-simulation warm-up period to a dynamic-simulation period at a respective color timescale group by simulating one or more time steps that add up to the target transition interval. During these transition time steps of the color timescale group, the system computes derived state values from a weighted combination of static estimates and dynamic derivations. The combination weights gradually migrate from predominantly static toward predominantly dynamic, thereby preventing an abrupt discontinuity in simulation data that could cause numerical instabilities or unphysical behavior within the simulation.

The intermediate state data, that can be estimated from static data or derived from dynamic phase-amplitude vector data, can include field-based properties, charge and density distributions, thermodynamic quantities, and coupling and response parameters. Field-based properties can describe how electromagnetic forces and fields vary throughout space and time, initially estimated from known material responses but later derived from local state data to capture the actual wave-like propagation and field interactions as the system develops its natural electromagnetic dynamics. Charge and density distributions can characterize where matter and electric charge are located within the system, initially estimated as theoretical predictions of atomic and molecular arrangements but later derived from local state data to reflect the true charge flows and redistributions that occur as chemical bonds form and quantum effects emerge. Thermodynamic quantities can represent the energy content and thermal behavior of the system, initially estimated from equilibrium assumptions about temperature and heat capacity but later derived from local state data into dynamic values that describe how energy moves between different physical processes and creates non-equilibrium thermal states. Coupling and response parameters quantify how strongly different physical phenomena influence each other, initially estimated from static material properties but later derived from local state data into computed measures that reflect the actual strength of interactions between electromagnetic, mechanical, thermal, and quantum effects as they develop through the simulation.

After a respective simulation time-step, the system may determine whether to store a simulation snapshot for analysis or visualization (step 814), such as whether the current global timestep corresponds to a snapshot interval. If so, the compute node can gather and store one or more simulation snapshot(s), as requested by the simulation configuration (step 816). The snapshot data may include component amplitude, magnitude, and/or phase data for some or all frequency components in one or more phase-amplitude vectors at specific mesh elements, such as from center points at mesh surfaces or center points at mesh volumes. The simulation system may store this snapshot data as a structured or unstructured mesh, or as a grid. The simulation system may also store derived quantities into the snapshot data, such as far-field electromagnetic radiation patterns at a remote observation surface beyond the CAD model's boundary. The simulation system may derive the far-field data from a projection of the oscillating frequency components of the phase-amplitude vectors at the outer boundary of the CAD model, representing the radiating electromagnetic fields that propagate to the far field. The simulation system may also store, into the snapshot data, phase correlation information between two distant points on the CAD model; this phase correlation information can provide insights into wave coherence properties.

The output snapshot data generated by the simulation system directly correlates with data that can be obtained from experimental measurements of the physical system being simulated. For example, the far-field electromagnetic data stored in the snapshot data can be compared with antenna pattern measurements or optical transmission spectra obtained from network analyzers or optical spectrometers. Also, the simulation system can store the frequency-domain nature of the phase-amplitude vectors into the snapshot data, which enables direct comparison with frequency-domain measurement instruments of the physical system without requiring additional post-processing transformations.

The system may also determine whether the simulation is complete (step 818), such as by checking convergence of a physical quantity or a time limit criterion to determine whether the simulation should continue. The system can check a convergence criterion by determining whether the maximum change in any physical quantity has fallen below a user-specified threshold, which would indicate that the system has reached a steady state. The time limit criteria may be a global maximum timestamp for the full simulation. The system may perform step 818 to determine whether the simulation is complete either after gathering and storing simulation snapshots(s) for the current simulation timestep (e.g., after step 816), or without gathering and storing simulation snapshot(s) for the current simulation timestep (e.g., after step 814).

In some embodiments, the simulation system may exchange boundary data between compute sub-domains only at simulation time steps that correspond to a predetermined simulation timestep interval. If the system determines at step 818 that the simulation is not yet complete, the system can determine whether the simulation is at a boundary-sync simulation interval (step 820). If so, the system can exchange boundary data between compute subdomains (e.g., compute node or GPU subdomains), to maintain continuity across the simulation domain (step 822), and the system may return to step 812 to process another set of simulation timesteps toward the next global timestep. If the simulation system is not at a boundary-sync simulation interval, the system can return to step 812 from step 820, without having to exchange boundary data between compute sub-domains. In some embodiments, the system can exchange boundary data by uploading, to a networked data store that includes the simulation results, simulation data for mesh elements substantially close to the boundary exchange regions.

Also, if the system determines at step 818 that the simulation is complete, the simulation system can process and store the final simulation results (step 824), which can include running one or more post-processing scripts that analyze the snapshot data to create a comprehensive view of the simulated physical system, and storing the results from these post-processing scripts along with the snapshot data. This post-processing step can combine data from different subdomains into a unified representation of the physical phenomena that were simulated. This post-processing may also include statistical analysis of the simulation data, deriving secondary quantities from the primary simulation data, performing data reduction to create a more compact representation of the simulation data, and/or formatting the simulation data for compatibility with visualization tools.

### Time Step Processing Using Checkerboard Approach

In some embodiments, the simulation system implements a timestep iteration at phase-amplitude vector pairs across the simulation domain via a checkerboard approach that uses color groups to ensure that no phase-amplitude vector is involved in multiple simultaneous vector coupling operations, thereby preventing race conditions and ensuring deterministic results. The simulation system can also define the different color groups by grouping vector pairs by their characteristic timescales and/or physical scales, which the simulation system can use to apply smaller time steps for phenomena that evolves rapidly, and larger time steps for phenomena that evolves slower.

Hence, the system can adjust coupling rates between phase-amplitude vectors based on their characteristic timescales and their mesh connectivity to ensure consistent physical behavior regardless of mesh structure. For example, for a vector-coupling operation between two phase-amplitude vectors, the system can adjust the coupling rate at a vector based on the corresponding color group's time step interval, the vector's characteristic timescale, a distance between the two vector's corresponding simulation points, and/or the percentage of element surface area that exists at the interaction face between the two vectors (i.e., the face shared by two adjacent elements of a vector-coupling operation). This adjustment allows the simulation system to ensure that physical processes (e.g., energy transfer or wave propagation) occur at physically accurate rates regardless of the specific mesh structure used to discretize the system.

This time-stepping approach balances physical accuracy with computational efficiency across multiple scales and physical domains. The following process steps can separate cross-element and same-element interactions into distinct phases with appropriate synchronization points, which allows the system to maintain physical consistency while maximizing parallel execution opportunities.

FIG. 9 illustrates a flow chart 900 for a time step simulation process performed by the simulation system to advance the simulation's physical state through each discrete time step using a checkerboard approach, in accordance with some embodiments of the present disclosure. The system processes the vector pair groups, where the vector pairs within a group can be processed in parallel. Each vector pair references two phase-amplitude vectors that interact with each other during the time step, where the two vectors reside from within the same mesh element or from adjacent mesh elements. For example, the vector-pair's data structure may include an element identifier and physical mode identifier for the first phase-amplitude vector, and may also include an element identifier and physical mode identifier for the second phase-amplitude vector. The vector-pair corresponds to a self-coupling operation when the identifiers are the same for the two phase-amplitude vectors. The system's parallel processing through the vector-pair group leverages the computational resources of available GPUs and/or CPUs, where each multi-core GPU or CPU may handle multiple vector-coupling procedures concurrently through its many processing cores.

Recall that not all vector pairs may need to interact at the same timestep interval; some vector pairs may have a simulation timestep interval that is larger than that of other vector pairs. The following process steps perform vector coupling for any color timescale group that needs to be simulated at a current simulation timestep. In some embodiments, the timescale for any color timescale group, or for any phase-amplitude vector, is either a multiple or a factor of the timescale of any other color timescale group. For the example where the color timescale groups have timestep intervals {2 ns, 20 ns, 100 ns} where each timestep interval is a multiple of the preceding timestep interval, all simulation timesteps may process the groups that advance at 2 ns increments, only simulation timesteps at multiples of 20 ns may process the second group, and only simulation timesteps at multiples of 100 ns may process the third group.

During a simulation timestep, a compute node can process a respective color timescale group of vector pairs, where the current timestep is a multiple of the group's timestep interval (step 902). The compute node can process the color group by configuring the one or more GPU thread blocks and/or CPUs to collaboratively iterate through the vector pairs in the group for parallel processing. For example, a respective GPU thread block or CPU core may determine whether there is an unprocessed vector-pair in the group (step 904), such as by using an atomic operation to increment a shared variable that indicates an index for the next vector-pair to process in the group, and determining whether the next vector-pair index is valid. If so, the respective GPU thread block or CPU core may process the vector-coupling operation for the next vector-pair in the group (step 906).

Once the respective GPU thread block or CPU core determines that there are no more vector-pairs to process in the group, the respective GPU thread block or CPU core may enter a synchronization barrier to synchronize with the other GPU thread blocks and/or CPU cores of the compute node before proceeding (step 908). This synchronization ensures that a GPU thread block or CPU core processing vector pairs in their current group does not encounter race condition interference with a different GPU thread block or CPU core that is processing vector pairs from a previous or later group. Once the compute node's GPU(s) and/or CPU(s) have synchronized, the compute node can proceed to determine whether there are more vector-pair groups to process for the current time step (step 910), such as by skipping over groups where the current timestep is not a multiple of the group's time scale. If the compute node identifies a vector-pair group to process, the compute node can return to operation 902 to allow the compute node's GPU thread-blocks and/or CPU cores to collaboratively process the next group's vector-pairs.

Recall that the simulation system may separate the different coupling types into different groups, such as cross-element same-mode couplings, cross-element cross-mode couplings, same-element cross-mode couplings, and self-couplings (e.g., same-element same-mode couplings). At a respective time step, while processing the color timescale groups that have a valid timestep interval at steps 902-906, the simulation system may first process the cross-element same-mode vector-pair groups, followed by the cross-element cross-mode vector-pair groups, followed by the same-element cross-mode vector-pair groups. Processing the cross-element same-mode coupling operation(s) between the vector pair can model how physical modes propagate across physical regions of space (e.g., between adjacent elements), such as electromagnetic wave propagation, heat diffusion, or mechanical stress transfer. The system performs a cross-element same-mode vector coupling operation for each direction between the corresponding phase-amplitude vectors of the vector pair to simulate the physical interaction of the same mode between two adjacent volumes of space represented by mesh elements.

Processing cross-element cross-mode coupling operations between the vector pair can model how different physical modes couple across physical regions of space, such as thermoelectric effects where temperature gradients generate electric fields across material interfaces, or piezoelectric effects where mechanical stress in one element influences electromagnetic fields in adjacent elements. Processing same-element cross-mode couplings can model how different physical modes influence each other within the same physical region of space (e.g., within the same mesh element), including material-specific coupling mechanisms such as electron-phonon coupling where electronic states interact with lattice vibrations, or photon-electron coupling where electromagnetic fields affect electronic states. The system performs a vector coupling operation for each direction between the corresponding phase-amplitude vectors of the vector pair to simulate the physical interaction of the different modes, either locally or between two adjacent regions of space represented by mesh elements.

In some embodiments, the simulation system may implement or activate only a subset of cross-mode vector couplings (e.g., for only a subset of all two-mode combinations of physical modes that the system can instantiate as phase-amplitude vectors). The simulation system may, for example, instantiate vector pairs only for the implemented and activated cross-mode vector couplings, thereby causing the system to perform step 906 only for the implemented and activated cross-mode vector couplings. The vector-coupling operations for these cross-mode interactions implement the material-specific coupling mechanisms that govern how different physical phenomena interact.

Once the compute node determines at step 910 that there are no more vector-pair groups to process, the compute node can continue by configuring the GPU thread blocks and/or CPU cores to collaboratively perform self-coupling interactions for the individual phase-amplitude vectors in their assigned simulation domain. Unlike the previous phase that handled vector couplings between two phase-amplitude vectors of the same element or adjacent elements, this phase processes vector couplings that occur within individual vectors, which allows the compute node's GPU thread blocks and/or CPU cores to process a CAD model's set of mesh elements in parallel without encountering a race condition between different bi-directional two-vector-coupling processes. These self-interactions can model how a physical mode evolves through internal dynamics, such as wave dispersion, nonlinear self-modulation, or quantum decoherence. The vector coupling operations for self-interactions implement the material-specific response functions that govern how each physical mode evolves over time.

The individual GPU thread blocks and/or CPU cores can determine whether there are any vector self-coupling operations that still need to be processed for the current simulation timestep (step 912). For example, the GPU thread blocks and/or CPU cores can iterate across one or more vector-pair groups that correspond to valid self-couplings for the current simulation timestep, where the current timestep is a multiple of the self-coupling group's time scale. Note that, because each self-coupling operation can be performed without experiencing race condition interference from other self-coupling operations, the GPU thread blocks and/or CPU cores can advance from one group to the next without having to enter a synchronization barrier until the respective GPU thread block or CPU core has iterated across all self-coupling groups.

When a respective GPU thread block or CPU core identifies a next phase-amplitude vector to process at step 912, the GPU thread block or CPU core can process the self-coupling operation at the selected phase-amplitude vector (step 914), and returns to operation 912 to select another phase-amplitude vector to process from the current group or a subsequent self-coupling group. Once the respective GPU thread block or CPU core determines at step 912 that there are no more phase-amplitude vectors to process for self-coupling operations, the respective GPU thread block or CPU core may enter a synchronization barrier to synchronize with the other GPU thread blocks and/or CPU cores of the compute node before proceeding (step 916). This synchronization ensures that the compute node's GPUs and/or CPUs have a consistent view of the updated physical state before proceeding to the next time step. The compute node may then update its simulation time to match the new global simulation timestep (step 918). This update tracks the progression of the simulation within the compute node, and determines when the local simulation reaches a checkpoint for synchronizing simulation data with other compute nodes of the simulation system.

The compute node may then proceed to the next time step, with or without synchronizing simulation data with the rest of the simulation system. Consider the example where three color timescale groups have timestep intervals {2 ns, 20 ns, 100 ns}. In some embodiments, the simulation system may be configured to synchronize GPUs across the simulation system's compute nodes at a configurable synchronization interval (e.g., the 20 ns timestep interval), configured either by a user or derived automatically to achieve a tradeoff between simulation accuracy and speed. Hence, the individual compute nodes may be allowed to iterate across the faster-evolving color groups independently (e.g., for 2 ns timestep intervals) without synchronizing with other compute nodes, until they reach the next synchronization interval (e.g., the 20 ns timestep interval). This configuration would reduce the amount of data synchronization that the simulation system would need to incur.

While this patent document contains many specifics, these should not be construed as limitations on the scope of any disclosed technology or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A computer-implemented method for simulating a physical system using a mathematical model, wherein the mathematical model defines a spatial domain comprising a plurality of simulation points, and wherein a respective simulation point includes at least one physical mode that represents a physical phenomenon within the physical system, the method comprising:
storing, in a memory, at least a first phase-amplitude vector that represents a first physical state for a first physical mode at a first simulation point in the spatial domain,
wherein the first phase-amplitude vector includes a plurality of frequency components that together define amplitudes across a frequency spectrum that defines the first physical state, and
wherein a respective frequency component comprises an amplitude coefficient that specifies an amplitude for a corresponding frequency of the frequency spectrum, and the respective frequency component corresponds to a measurable physical frequency of electromagnetic radiation, phonon vibrations, or electron oscillations in the physical system;
computing a vector-coupling operation between the first phase-amplitude vector and a second phase-amplitude vector that represents a second physical state for a second physical mode to generate amplitude contributions that affect the first physical state represented by the first phase-amplitude vector, wherein the vector-coupling operation models energy transfer between the first physical state and the second physical state in the physical system according to physical conservation laws, and wherein computing the vector-coupling operation comprises:
obtaining a first frequency component of the first phase-amplitude vector;
obtaining a second frequency component of the second phase-amplitude vector;
identifying a target frequency component to update in the first phase-amplitude vector, based on a combination of the frequency values associated with the first frequency component and the second frequency component; and
generating an amplitude contribution to the amplitude coefficient of the target frequency component; and
updating the first phase-amplitude vector based on the computed amplitude contributions.

2. The method of claim 1, wherein computing the vector-coupling operation on the first phase-amplitude vector comprises evolving a physical state at the first simulation point of the spatial domain.

3. The method of claim 1, wherein the first phase-amplitude vector includes an array of frequency coefficients, and wherein a respective array location maps to a corresponding frequency component.

4. The method of claim 3, wherein the array locations map to the corresponding frequency values via a configurable mapping function, which can be configured to operate as a linear mapping function or a non-linear mapping function based on a configurable mapping-scale parameter, S.

5. The method of claim 1, wherein the second phase-amplitude vector corresponds to a second simulation point that is adjacent to the first simulation point within the spatial domain; and
wherein the vector-coupling operation computes an interaction between the first simulation point and the second simulation point.

6. The method of claim 1, wherein the second physical mode is different from the first physical mode; and
wherein the vector-coupling operation computes an interaction between the first physical mode and the second physical mode.

7. The method of claim 1, further comprising:
computing a vector-coupling rate based at least on a characteristic timescale associated with the first phase-amplitude vector; and
adjusting the amplitude contribution to the amplitude coefficient based at least on the vector-coupling rate, thereby adapting a rate of the vector-coupling operation based on the characteristic timescale.

8. The method of claim 1, further comprising:
storing the first phase-amplitude vector in a shared memory of a graphics processing unit; and
wherein performing the vector-coupling operation comprises:
reading the first frequency component from the shared memory; and
generating the amplitude contribution to the amplitude coefficient by a processing unit of the graphics processing unit.

9. The method of claim 1, further comprising:
enforcing energy conservation during the vector-coupling operation by calculating a total energy value before the vector-coupling operation and a total energy value after the vector-coupling operation;
wherein the total energy value is based on a sum of energy contributions from the frequency components; and
wherein a respective energy contribution is proportional to a magnitude squared of an amplitude coefficient corresponding to the respective frequency component multiplied by a frequency value corresponding to the respective frequency component.

10. The method of claim 9, further comprising:
computing a scaling factor as a square root of a ratio of the total energy value before the vector-coupling operation to the total energy value after the vector-coupling operation; and
applying the scaling factor to the updated amplitude coefficients to preserve the total energy value across the vector-coupling operation.

11. The method of claim 1, wherein computing the vector-coupling operation comprises performing a sum frequency-mixing operation, and wherein the sum frequency-mixing operation comprises:
calculating a sum frequency by adding a first frequency value corresponding to the first frequency component and a second frequency value corresponding to the second frequency component;
determining a sum frequency target component in the first phase-amplitude vector that corresponds to the calculated sum frequency; and
generating a sum frequency amplitude contribution to the sum frequency target component based on a product of the amplitude coefficient of the first frequency component and the amplitude coefficient of the second frequency component.

12. The method of claim 1, wherein computing the vector-coupling operation comprises performing a difference frequency-mixing operation, and wherein the difference frequency-mixing operation comprises:
calculating a difference frequency by taking an absolute value of a difference between a first frequency value corresponding to the first frequency component and a second frequency value corresponding to the second frequency component;
determining a difference frequency target component in the first phase-amplitude vector that corresponds to the calculated difference frequency; and
generating a difference frequency amplitude contribution to the difference frequency target component based on a product of the amplitude coefficient of the first frequency component and the amplitude coefficient of the second frequency component.

13. A computer system for simulating a physical system using a mathematical model, wherein the mathematical model defines a spatial domain comprising a plurality of simulation points, and wherein a respective simulation point includes at least one physical mode that represents a physical phenomenon within the physical system, the computer system comprising:
a memory configured to store at least a first phase-amplitude vector that represents a first physical state for a first physical mode at a first simulation point in the spatial domain,
wherein the first phase-amplitude vector includes a plurality of frequency components that together define amplitudes across a frequency spectrum that defines the first physical state, and
wherein a respective frequency component comprises an amplitude coefficient that specifies an amplitude for a corresponding frequency of the frequency spectrum, and the respective frequency component corresponds to a measurable physical frequency of electromagnetic radiation, phonon vibrations, or electron oscillations in the physical system; and
a processor configured to:
compute a vector-coupling operation between the first phase-amplitude vector and a second phase-amplitude vector that represents a second physical state for a second physical mode to generate amplitude contributions that affect the first physical state represented by the first phase-amplitude vector, wherein the vector-coupling operation models energy transfer between the first physical state and the second physical state in the physical system according to physical conservation laws, and wherein computing the vector-coupling operation comprises:
obtaining a first frequency component of the first phase-amplitude vector;
obtaining a second frequency component of the second phase-amplitude vector;
identifying a target frequency component to update in the first phase-amplitude vector, based on a combination of the frequency values associated with the first frequency component and the second frequency component; and
generating an amplitude contribution to the amplitude coefficient of the target frequency component; and
update the first phase-amplitude vector based on the computed amplitude contributions.

14. The computer system of claim 13, further comprising:
a graphics processing unit having a shared memory configured to store the first phase-amplitude vector; and
wherein the processor is configured to perform the vector-coupling operation by:
reading the first frequency component from the shared memory; and
generating the amplitude contribution to the amplitude coefficient by a processing unit of the graphics processing unit.

15. The computer system of claim 13, wherein the processor is further configured to:
enforce energy conservation during the vector-coupling operation by calculating a total energy value before the vector-coupling operation and a total energy value after the vector-coupling operation;
wherein the total energy value is based on a sum of energy contributions from the frequency components; and
wherein a respective energy contribution is proportional to a magnitude squared of an amplitude coefficient corresponding to the respective frequency component multiplied by a frequency value corresponding to the respective frequency component.

16. The computer system of claim 15, wherein the processor is further configured to:
compute a scaling factor as a square root of a ratio of the total energy value before the vector-coupling operation to the total energy value after the vector-coupling operation; and
apply the scaling factor to the updated amplitude coefficients to preserve the total energy value across the vector-coupling operation.

17. The computer system of claim 13, wherein computing the vector-coupling operation comprises performing a sum frequency-mixing operation, and wherein the sum frequency-mixing operation comprises:
calculating a sum frequency by adding a first frequency value corresponding to the first frequency component and a second frequency value corresponding to the second frequency component;
determining a sum frequency target component in the first phase-amplitude vector that corresponds to the calculated sum frequency; and
generating a sum frequency amplitude contribution to the sum frequency target component based on a product of the amplitude coefficient of the first frequency component and the amplitude coefficient of the second frequency component.

18. The computer system of claim 13, wherein computing the vector-coupling operation comprises performing a difference frequency-mixing operation, and wherein the difference frequency-mixing operation comprises:
calculating a difference frequency by taking an absolute value of a difference between a first frequency value corresponding to the first frequency component and a second frequency value corresponding to the second frequency component;
determining a difference frequency target component in the first phase-amplitude vector that corresponds to the calculated difference frequency; and
generating a difference frequency amplitude contribution to the difference frequency target component based on a product of the amplitude coefficient of the first frequency component and the amplitude coefficient of the second frequency component.

19. A non-transitory computer-readable medium storing instructions that, when executed by a processor, cause the processor to perform operations for simulating a physical system using a mathematical model, wherein the mathematical model defines a spatial domain comprising a plurality of simulation points, and wherein a respective simulation point includes at least one physical mode that represents a physical phenomenon within the physical system, the operations comprising:
storing, in a memory, at least a first phase-amplitude vector that represents a first physical state for a first physical mode at a first simulation point in the spatial domain,
wherein the first phase-amplitude vector includes a plurality of frequency components that together define amplitudes across a frequency spectrum that defines the first physical state, and
wherein a respective frequency component comprises an amplitude coefficient that specifies an amplitude for a corresponding frequency of the frequency spectrum, and the respective frequency component corresponds to a measurable physical frequency of electromagnetic radiation, phonon vibrations, or electron oscillations in the physical system;
computing a vector-coupling operation between the first phase-amplitude vector and a second phase-amplitude vector that represents a second physical state for a second physical mode to generate amplitude contributions that affect the first physical state represented by the first phase-amplitude vector, wherein the vector-coupling operation models energy transfer between the first physical state and the second physical state in the physical system according to physical conservation laws, and wherein computing the vector-coupling operation comprises:
obtaining a first frequency component of the first phase-amplitude vector;
obtaining a second frequency component of the second phase-amplitude vector;
identifying a target frequency component to update in the first phase-amplitude vector, based on a combination of the frequency values associated with the first frequency component and the second frequency component; and
generating an amplitude contribution to the amplitude coefficient of the target frequency component; and
updating the first phase-amplitude vector based on the computed amplitude contributions.

20. The non-transitory computer-readable medium of claim 19, wherein the operations further comprise:
storing the first phase-amplitude vector in a shared memory of a graphics processing unit; and
wherein performing the vector-coupling operation comprises:
reading the first frequency component from the shared memory; and generating the amplitude contribution to the amplitude coefficient by a processing unit of the graphics processing unit.

21. The non-transitory computer-readable medium of claim 19, wherein the operations further comprise:
enforcing energy conservation during the vector-coupling operation by calculating a total energy value before the vector-coupling operation and a total energy value after the vector-coupling operation;
wherein the total energy value is based on a sum of energy contributions from the frequency components; and
wherein a respective energy contribution is proportional to a magnitude squared of an amplitude coefficient corresponding to the respective frequency component multiplied by a frequency value corresponding to the respective frequency component.

22. The non-transitory computer-readable medium of claim 21, wherein the operations further comprise:
computing a scaling factor as a square root of a ratio of the total energy value before the vector-coupling operation to the total energy value after the vector-coupling operation; and
applying the scaling factor to the updated amplitude coefficients to preserve the total energy value across the vector-coupling operation.

23. The non-transitory computer-readable medium of claim 19, wherein computing the vector-coupling operation comprises performing a sum frequency-mixing operation, and wherein the sum frequency-mixing operation comprises:
calculating a sum frequency by adding a first frequency value corresponding to the first frequency component and a second frequency value corresponding to the second frequency component;
determining a sum frequency target component in the first phase-amplitude vector that corresponds to the calculated sum frequency; and
generating a sum frequency amplitude contribution to the sum frequency target component based on a product of the amplitude coefficient of the first frequency component and the amplitude coefficient of the second frequency component.

24. The non-transitory computer-readable medium of claim 19, wherein computing the vector-coupling operation comprises performing a difference frequency-mixing operation, and wherein the difference frequency-mixing operation comprises:
calculating a difference frequency by taking an absolute value of a difference between a first frequency value corresponding to the first frequency component and a second frequency value corresponding to the second frequency component;
determining a difference frequency target component in the first phase-amplitude vector that corresponds to the calculated difference frequency; and
generating a difference frequency amplitude contribution to the difference frequency target component based on a product of the amplitude coefficient of the first frequency component and the amplitude coefficient of the second frequency component.
